(19) United States
(12) Patent Application Publication
(10) Pub. No.: US 2012/0276367 A1
(43) Pub. Date: Nov. 1, 2012

(54) CAST FILMS, MICROPOROUS MEMBRANES, AND METHOD OF PREPARATION THEREOF

(76) Inventors: Pierre Carreau, Brossard (CA); Seyed Hesamoddin Tabatabaei, Montreal (CA); Abdellah Ajji, Mont-Royal (CA)

(21) Appl. No.: 13/379,272

(22) PCT Filed: Jun. 18, 2010
(86) PCT No.: PCT/CA2010/000952

§ 371 Date: Mar. 19, 2012

Related U.S. Application Data
(60) Provisional application No. 61/219,581, filed on Jun. 23, 2009.
(60) Provisional application No. 61/288,042, filed on Dec. 18, 2009.

(51) Int. Cl. B29C 47/88; B32B 3/26; B29C 47/06

(52) U.S. Cl. 428/315.5; 264/211.12; 264/171.1

(57) ABSTRACT

There is provided a method for controlling the morphology of a cast film. The method comprises extruding a cast film by controlling a cooling rate of the cast film by applying on the film a gas at a gas cooling rate of at least about 0.4 cm³/s per kg/hr in accordance with the extrudate flow rate.

### FIELD OF THE DISCLOSURE

The present disclosure relates to the field of microporous membranes obtained by means of cast films precursors. More particularly, the disclosure relates to a method of controlling the morphology of cast films.

### BACKGROUND OF THE DISCLOSURE

Among a wide range of resins, polypropylene (PP) is a well-known semicrystalline polymer and, in comparison with polyethylene (PE), PP has a higher melting point, lower density, higher chemical resistance, and better mechanical properties, which make it useful for many industrial applications.

The crystalline phase orientation in semicrystalline polymers such as polypropylene enhances many of their properties particularly mechanical, impact, barrier, and optical properties [1]. Obtaining an oriented structure in PP is of great interest to many processes such as film blowing, fiber spinning, film casting, and etc. In these processes the polymer melt is subjected to shear (in the die) and elongational (at the die exit) flow and crystallize during or subsequent to the imposition of the flow.

It is well-known that strain under flow strongly enhances the crystallization kinetics and allows the formation of a lamellar structure instead of the spherulitic one. The effect of flow on crystallization is called flow-induced crystallization (FIC) while the flow can be shear, extensional or both [2]. FIC molecular models show that flow induces orientation of polymer chains, resulting in enhancement of the nucleation rate [2-4]. Under flow, two major types of crystallization can occur, depending on the magnitude of the stress [1]: low stress results in twisted lamellae, while high stress produces a shish-kebab structure in which the lamellae grow radially on the shish without twisting [1].

Similar to shear flow, it has also been reported that extensional flow promotes fibrillar like structure oriented in the flow direction that serves as nucleation for radial growth of chain-folded lamellae perpendicular to the stress direction [5].

The effects of material parameters on shear induced crystallization process for PP have been investigated using in-situ small angle X-ray scattering (SAXS) and/or wide angle X-ray diffraction (WAXD) analyses [6-8]. Agarwal et al. [6] examined the influence of long chain branches on the stress induced crystallization. Adding a certain level of branches improved the orientation of the crystal blocks and the crystallization kinetics due to the longer relaxation time and the molecular structure. Somani et al. [7] followed the orientation development upon applying different shear rates. They found that, at a certain shear rate, only molecules with a chain length (molecular weight) above a critical value (critical orientation molecular weight, M_{c}) can form stable oriented row nuclei (shish). The shorter chains create lamellae over these nuclei sites. In another study, Somani et al. [8] compared the oriented microstructure under shear flow of isotactic polypropylene melts (PP-A and PP-B) with the same number average molecular weight but different molecular weight distribution (MWD). The amount of the high molecular weight species was larger in PP-B than in PP-A. Their results showed that the shish structure evolved much earlier for PP-B, which had more pronounced crystal orientation and faster crystallization kinetics. They concluded that even a small increase in the concentration of the high molecular weight chains led to a significant increase in the shish or nuclei site formation. In our recent study [9], addition of up to 10 wt % of a high molecular weight component to a low molecular weight one enhanced the formation of the row-nucleated structure probably due to an increase in the nucleating sites.

The crystallization behavior of semicrystalline polymers is significantly influenced by the process conditions. Under quiescent isothermal crystallization, the size of the spherulites, the degree of crystallinity, and the kinetics depend on temperature, while in quiescent non-isothermal conditions, both temperature and cooling rate are influencing factors [2].

Numerous studies have focused on the structure of PE and PP blown films using various materials under different processing conditions. However, as far as Applicants know no experimental study has been conducted on the cast film process with emphasis on the various parameters that can influence the morphology of the films.

Microporous membranes are commonly used in separation processes such as battery separators and medical applications to control the permeation rate of chemical components. Due to the wide range of chemical structures, optimum physical properties, and low cost of polymers and polymer blends, these materials are known as the best candidates for the fabrication of microporous membranes.

The two main techniques to develop polymeric membranes are: solution casting and extrusion followed by stretching. High cost and solvent contamination are the main drawbacks of the solution technique. Techniques to make porous membranes from polymers without using any solvent were developed in the seventies of the last century for some applications, but most of the information on these processes remains proprietary to the companies' and are not available to the scientific community. One of the techniques is based on the stretching of a polymer film containing a row-nucleated lamellar structure [29]. Then, three consecutive stages are carried out to obtain porous membranes: (1) creating a precursor film having a row-nucleated lamellar structure by mechanism of shear and elongation-induced crystallization, (2) annealing the precursor film at temperatures near the melting point of the resin to remove imperfections in the crystalline phase and to increase lamellae thickness, and (3) stretching at low and high temperatures to create and enlarge pores, respectively [29, 30]. In fact, in this process the material variables as well as the applied processing conditions are parameters that control the structure and the final properties of the fabricated microporous membranes [29]. The material variables include molecular weight, molecular weight distribution, and chain structure of the polymer. These factors mainly influence the row-nucleated structure in the precursor films at the first step of the formation of microporous membranes.

A few studies have investigated the fabrication of porous membranes by stretching of lamellar morphology using polypropylene [35-37]. Sadeghi et al. [35, 36] considered the influence of molecular weight on orientation of the row-nucleated lamellar structure. They found that molecular weight was the main material parameter that controlled the orientation of the crystalline phase. It was demonstrated that the resin with high molecular weight developed larger orientation and thicker lamellae than the resin with low molecular weight. Sadeghi et al. [37] realized that an initial orientation was required in order to obtain a lamellar structure. The crystalline orientation in the precursor film depended on the molecular weight of the resin and the type of process (i.e. cast film or film blowing). It was shown that the cast film process was more efficient than film blowing for producing precursor films with the appropriate crystalline orientation.

Although quite a few authors have investigated the formation of porous membranes from various resins, information is still lacking on the control of morphology and performances of membranes.

### SUMMARY OF THE DISCLOSURE

According to one aspect, there is provided a method for controlling the morphology of a cast film, the method comprising extruding a cast film by controlling a cooling rate of the cast film by applying on the film a gas at a gas cooling rate of at least about 0.4 cm³/s per kg/hr.

According to one aspect, there is provided a method for controlling the morphology of a cast film, the method comprising extruding a cast film by controlling a cooling rate of the cast film by applying on the film a gas at a gas cooling rate of at least about 0.4 cm³/s per kg/hr in accordance with the extrudate flow rate.

According to another aspect, there is provided a method for preparing a microporous membrane comprising preparing a cast film by controlling the morphology of the cast film as indicated in the method previously described, annealing the film, and stretching the film.

According to another aspect, there is provided a multilayer microporous membrane comprising at least two cast films prepared by controlling the morphology of the cast films as indicated in the method previously described.

According to another aspect, there is provided a method of preparing a microporous membrane comprising preparing a multilayer cast film, annealing the film, and stretching the film.

According to another aspect, there is provided a method of preparing a microporous membrane comprising preparing a multilayer cast film, annealing the film, and stretching the film, wherein the multilayer cast film comprises, in the following order, a first polypropylene layer, a polyethylene layer, and a second polypropylene layer.

According to another aspect, there is provided a method of preparing a microporous membrane comprising preparing a multilayer cast film, annealing the film, and stretching the film, wherein the multilayer cast film comprises, in the following order, a first linear polypropylene layer, a high density polyethylene layer, and a second linear polypropylene layer.

### BRIEF DESCRIPTION OF THE DRAWINGS

In the appended drawings which represent various examples of the present disclosure:

FIG. 1 represents DSC scans of cast films according to an example of the present disclosure for roll temperatures of 120, 110, and 100° C., wherein the top curves are the thermograms of cast films produced under N-AFR (no air flow rate) condition whereas the bottom curves are the thermograms of films fabricated under L-AFR (low air flow rate); DR=75 (draw ratio=75);

FIG. 2 is a graph showing crystalline orientation functions of examples according to the present disclosure as a function of different cast roll temperatures, wherein the inset is a plot of the crystalline orientation function versus the air flow rate conditions for T_{cast}=120° C.; DR=75;

FIG. 3 is a graph showing amorphous orientation functions of examples according to the present disclosure for different cast roll temperatures, wherein the inset is a plot of the amorphous orientation function versus the air flow rate conditions for T_{cast}=120° C.; DR=75;

FIG. 4 is a plot showing the crystal orientation functions of examples according to the present disclosure as a function of different air flow rate conditions at draw ratios (DR) of 60, 75, and 90; T_{cast}=120° C.;

FIG. 5 represents 2D WAXD patterns and azimuthal intensity profiles at 20 of the 110 refection plane of examples of films according to the present disclosure at different air cooling conditions; T_{cast}=120° C. and DR=75;

FIG. 6 represents pole figures for examples according to the present disclosure that have been obtained under different air cooling conditions. a) N-AFR, b) L-AFR, and c) M-AFR (medium air flow rate); T_{cast}=120° C. and DR=75, wherein schematics show the assumed crystal orientation;

FIG. 7 represents orientation characteristics as cos² (φ) of the crystal axes (a, b and c) along MD, TD, and ND; T_{cast}=120° C. and DR=75 examples according to the present disclosure, wherein the schematic represents the film production axes and crystal block coordinates;

FIG. 8 represents 2D SAXS patterns and azimuthal intensity profiles at the meridian of examples according to the present disclosure for different air flow cooling conditions; T_{cast}=120° C. and DR=75;

FIG. 9 shows Lorentz corrected SAXS intensity profiles for examples according to the present disclosure and that have been prepared under various air cooling conditions; T_{cast}=120° C. and DR=75;

FIG. 10 shows SEM micrographs of examples of the surface according to the present disclosure, wherein the films have been obtained under: a) N-AFR and T_{cast}=120° C., b) N-AFR and T_{cast}=110° C., and c) L-AFR and T_{cast}=120° C., wherein the right images represent high magnification micrographs of the sections corresponding to the rectangles; DR=75, MD ↑ and TD →I

FIG. 11 represent typical stress-strain behavior curves of examples according to the present disclosure, wherein the films have been prepared under N-AFR and L-AFR conditions along MD (top curve) and TD (bottom curve); T_{cast}=120° C. and DR=75;

FIGS. 12A, 12B, 12C, and 12D show, for examples according to the present disclosure, curves related to mechanical properties of the films along MD for various air flow rate conditions, wherein the films have been prepared under T_{cast}=120° C. and DR=75;

FIG. 13 shows, for examples according to the present disclosure, elongation at break (top curve) and yield stress (bottom curve) of the films along TD for various air flow rate conditions, wherein the films have been prepared under T_{cast}=120° C. and DR=75;

FIGS. 14A and 14B show, for examples according to the present disclosure, proposed pictograms of the molecular structure for: no air cooled cast films (FIG. 14A) and air cooled cast films (FIG. 14B) (the solid lines represent the tear path along MD and the dash lines show the tear path along TD);

FIG. 15 shows, for examples according to the present disclosure, weighted relaxation spectra for different melt temperatures (the vertical dash lines represent the range of frequencies covered during the experiments);

FIGS. 16A and 16B show, for examples according to the present disclosure, SEM micrographs of the surface of the films obtained at: N-AFR (FIG. 16A) and L-AFR (FIG. 16B), wherein the films have been prepared under the following conditions: T_{cast}=120° C. and DR=75, cold stretching of 35%, followed by hot stretching of 55%. MD ↑ and TD →;

FIG. 17 is a graph showing, for examples according to the present disclosure, water vapor transmission rate (WVTR) as a function of cast roll temperature, wherein the inset is a plot of WVTR as a function of air flow rate condition for T_{cast}=120° C.;

FIG. 18 shows curves, for examples according to the present disclosure, in which complex viscosity is expressed as a function of angular frequency (T=190° C.);

FIG. 19 shows curves, for examples according to the present disclosure, in which complex viscosity at different angular frequencies is expressed as a function of PP08 content (T=190° C.);

FIG. 20 shows, shows curves, for examples according to the present disclosure, of weighted relaxation spectra for the neat PPs as well as for all the blends; T=190° C. (the vertical dash lines represent the range of frequencies covered during the experiments);

FIG. 21 shows, for examples according to the present disclosure, Cole-Cole plots for the neat PPs as well as for all the blends (T=190° C.);

FIG. 22 shows, for examples according to the present disclosure, crystalline orientation function (obtained from FTIR) as a function of draw ratio for precursor films;

FIG. 23 is a graph showing, for examples according to the present disclosure, crystallinity of films at various annealing conditions. (a) annealing at 140° C., (b) annealing at 140° C. under 5% extension, and (c) annealing at 120° C., wherein annealing was performed for 30 min; DR=70, cold stretching of 35% followed by hot stretching of 55%;

FIG. 24 shows, for examples according to the present disclosure, crystalline and amorphous orientation parameters as a function of PP08 content, wherein annealing was performed at 140° C. for 30 min (DR=70);

FIG. 25 is a graph showing, for examples according to the present disclosure, crystallinity of precursor films, annealed films, and membranes as a function of PP08 content, wherein annealing was carried out at 140° C. for 30 min; DR=70, cold stretching of 35% followed by hot stretching of 55%;

FIGS. 26A, 26B, 26C, 26D, and 26E show, for examples according to the present disclosure, WAXD patterns of 10 wt % PP08 blend for precursor film, annealed sample, membrane, orientation features as cos² of the crystals along MD, TD, and ND, and diffraction spectrum with integration through the circles, wherein annealing was performed at 140° C. for 30 min; DR=70, cold stretching of 35% followed by hot stretching of 55%;

FIG. 27 shows, for examples according to the present disclosure, SAXS intensity profiles for precursor, annealed, and stretched 10 wt % PP08 films, wherein annealing was performed at 140° C. for 30 min; DR=70, cold stretching of 35% followed by hot stretching of 55%;

FIGS. 28A and 28B show, for examples according to the present disclosure, SAXS patterns of precursor films: PP28 (FIG. 28A) and 10 wt % PP08 (FIG. 28B); DR=70;

FIG. 29 shows, for examples according to the present disclosure, normalized maximum force for piercing as a function of PP08 content, wherein annealing was performed at 140° C. for 30 min; DR=70 and strain rate=25 mm/min;

FIG. 30 shows, for examples according to the present disclosure, elongation at break for precursor films along the MD as a function of PP08 content (DR=70 and strain rate=25 mm/min);

FIG. 31, shows, for examples according to the present disclosure, stress-strain curves along TD for precursor films of PP28 and blends (DR=70 and strain rate=25 mm/min);

FIGS. 32A, 32B, 32C and 32D shows, for examples according to the present disclosure, WAXD patterns of the annealed films PP28 (FIG. 32A), 10 wt % PP08 blend (FIG. 32A), film production axes and crystal block coordinates (FIGS. 32C and 32D), wherein annealing was performed at 140° C. for 30 min; DR=70;

FIGS. 33A1, 33A2, 33B1, 33B2, 33C1 and 33C2 shows, for examples according to the present disclosure, SEM micrographs of the surface (top images) and cross-section (bottom images) of the microporous membranes. made with: PP28 (FIGS. 33A1 and 33A2), 5 wt % PP08 blend (FIGS. 33B1 and 33B2), and 10 wt % PP08 blend (FIGS. 33C1 and 33C2); DR=70, cold stretching of 35%, followed by hot stretching of 55;

FIG. 34 shows, for examples according to the present disclosure, pore size distribution for microporous PP28, 5 wt % blend, and 10 wt % blend membranes (DR=70, cold stretching of 35% followed by hot stretching of 55%);

FIG. 35 shows, for examples according to the present disclosure, normalized water vapor permeability for the 10 wt % PP08 blend membrane as a function of extension during cold stretching at temperatures of 25° C. and 45° C., DR=70, hot stretching of 55%, and draw speed=50 mm/min;

FIG. 36 shows, for examples according to the present disclosure, normalized water vapor permeability for the 10 wt % PP08 blend membrane as a function of extension during hot stretching at temperatures of 140° C. and 120° C., DR=70, cold stretching of 35%, and draw speed=50 mm/min;

FIG. 37 shows, for examples according to the present disclosure, complex viscosity as a function of angular frequency (T=190° C.), wherein the inset is weighted relaxation spectra for the resins (the vertical dash lines represent the range of frequencies covered during the experiments);

FIG. 38 shows, for examples according to the present disclosure, DSC heating thermograms for single layers as well as multilayer films (DR=90 and H-AFR);

FIG. 39 shows, for examples according to the present disclosure, normalized 2D WAXD patterns and diffraction spectrum with integration through the circles for PP and HDPE monolayer films (DR=90 and H-AFR);

FIGS. 40A, 40B and 40C show, for examples according to the present disclosure, normalized 2D WAXD patterns and pole figures for films obtained under different DR, AFR, and annealing: PP monolayer (FIG. 40A), PP in multilayer (FIG. 40B), and HDPE monolayer (FIG. 40C), wherein annealing was performed at 120° C. for 30 min;

FIGS. 41A, 41B and 41C show, for examples according to the present disclosure, orientation characteristics as cos² (φ) of the crystal axes (a, b and c) along MD, TD, and ND for the films obtained under different DR, AFR, and annealing: c-axis (FIG. 41A), a-axis (FIG. 41B), and b-axis (FIG. 41C), wherein annealing was performed at 120° C. for 30 min;

FIG. 42 shows, for examples according to the present disclosure, Lorentz corrected SAXS intensity profiles for precursor and annealed PP and HDPE films, wherein annealing was performed at 120° C. for 30 min, DR=90 and H-AFR;

FIG. 43 shows, for examples according to the present disclosure, SEM micrographs of the surface of the etched precursor films: (a) PP and (b) HDPE, wherein the right images are high magnification micrographs of the left ones; DR=90 and H-AFR, MD ↑ and TD →;

FIG. 44 shows, for examples according to the present disclosure, interfacial morphology of etched PP/HDPE multilayer films at different magnifications, DR=90 and H-AFR, MD ↑ and ND →;

FIG. 45 shows, for examples according to the present disclosure, SEM micrographs of the surface of microporous membranes (20 μm thick): (a) PP and (b) HDPE; DR=90, H-AFR, cold stretching of 55%, followed by hot stretching of 75%. MD ↑ and TD →;

FIG. 46 shows, for examples according to the present disclosure, SEM micrographs of the cross-section of trilayer microporous membranes (20 μm thick) at different magnifications; DR=90, H-AFR, cold stretching of 55%, followed by hot stretching of 75%;

FIG. 47 shows, for examples according to the present disclosure, normalized water vapor permeability for PP and HDPE membranes as a function of extension during cold stretching at 25° C., DR=90, H-AFR, hot stretching of 75%;

FIG. 48 shows, for examples according to the present disclosure, stress-strain behavior for annealed PP and HDPE during the cold stretching step, wherein annealing was performed at 120° C. for 30 min, DR=90, H-AFR;

FIG. 49 shows, for examples according to the present disclosure, nitrogen adsorption isotherms (77 K) measured by BET for PP and HDPE membranes, (DR=90, H-AFR, cold stretching of 35%, followed by hot stretching of 75%); and

FIG. 50 shows, for examples according to the present disclosure, SEM micrographs of the cross-section of multilayer microporous membranes; DR=90, H-AFR, cold stretching of 55%, followed by hot stretching of 175% (the arrows indicate the connection of the HDPE interlamellar microfibrils to the lamellae).

FIG. 51 is a schematic representation of an apparatus used for carrying out an example of a method according to the present disclosure, wherein there is shown the distance between the die exit to the nip roll, and wherein delta X represents (Td-Tc) the difference of temperature between the extruder and the cast toll (cooling drum) and the Tcast, wherein Ua and Ta represents the gas cooling rate and the temperature of the gas;

### DETAILED DESCRIPTION OF THE DISCLOSURE

The following embodiments are presented as non-limiting examples.

In the method previously mentioned, the gas used for cooling the film can be air. It can also be various other gases commercially vailable such as nitrogen, argon, helium etc.

For example, the cast film can be prepared by extruding the film at a draw ratio (DR) of at least 50, 55, 60, 65, 70, 75, or 80. For example, the draw ration can be about 50 to about 100 or about 60 to about 90.

For example, the film can have a thickness of about 20 μm to about 60 μm, about 30 μm to about 50 μm, or about 32 μm to about 45 μm.

According to one embodiment, the gas can be blown on the film by means of at least one air knife.

For example the cast film can be a monolayer film or a multilayer film (such as having from 2 to 10 layers, 2 to 7 layers, 2 to 5 layers, 2 to 4 layers, 2 layers or 3 layers).

For example, the gas cooling rate can be of at least 0.5, 0.6, 0.7, 0.8, 0.9, 1.0, 1.2, 1.5, 2.0, 3.0, 3.5, 4.0, 4.5, 5.0, 5.5, 6.0, 6.5, 7.0, 7.5, 8.0, 8.5, or 10 cm³/s per kg/hr in accordance with the extrudate flow rate. Alternatively, the gas cooling rate can be about 0.5 to about 9.0, about 0.6 to about 5.5, or 0.7 to about 4.5 cm³/s per kg/hr in accordance with the extrudate flow rate.

For example, the gas cooling rate can be at least proportional to square of the extrudate flow rate or it can be proportional to the reciprocal of extrudate film width.

According to one embodiment, the film can be extruded by means of a die and rolled up on a at least one cooling drum.

For example, the least one cooling drum can be at a temperature of about 20° C. to about 150° C., about 40° C. to about 140° C., about 50° C. to about 140° C., about 75° C. to about 140° C., about 80° C. to about 130° C., about 85° C. to about 115° C., about 90° C. to about 120° C., or about 100° C. to about 110° C.

For example, the can film comprise polypropylene, polyethylene or a mixture thereof.

For example, the can film comprise linear polypropylene, high density polyethylene, or a mixture thereof.

For example, the film can have a lamellar crystal structure. For example, the film can have a crystallinity of at least 40, 50, 60, 70, 80, or 90%.

When preparing a microporous membrane by using a cast film prepared according to the method as previously discussed, the film can be annealed at temperatures below the melting temperature. For example, the film can also be annealed at a temperature of about 100° C. to about 150° C., about 110° C. to about 140° C., or about 120° C. to about 140° C. For example, the film can be stretched at a first temperature and the film can be stretched at a second temperature. For example, the first temperature can be about 10° C. to about 50° C., about 15° C. to about 40° C., or 20° C. to about 30° C. For example, the second temperature can be about 90° C. to about 150° C., about 100° C. to about 140° C., or about 110° C. to about 130° C.

For example, the film can be stretched of about 20% to about 75% at the first temperature and the film can be stretched of about 40 to about 200% at the second temperature.

For example, the film can be stretched of about 30% to about 70% at the first temperature and the film can be stretched of about 50 to about 175% at the second temperature.

For example, the film can be stretched of about 30% to about 40% at the first temperature and the film can be stretched of about 50 to about 60% at the second temperature.

For example, the film can be stretched of about 50% to about 60% at the first temperature and the film can be stretched of about 70 to about 80% at the second temperature.

When preparing a multilayer microporous membrane comprising at least two cast films prepared by controlling the morphology of the cast films as described in the method previously mentioned the at least two cast films can be annealed and stretched. For example, the at least two cast films can be annealed at temperatures below the melting temperature of each film. For example, the at least two cast films can be annealed at about 100° C. to about 130° C., about 110° C. to about 130° C., or about 120° C. to about 130° C.

For example, the at least two films can be stretched at a first temperature and then the at least two films can be stretched at a second temperature. For example, the first temperature can be about 10° C. to about 50° C., about 15° C. to about 40° C., or about 20° C. to about 30° C. For example, the second temperature can be about 90° C. to about 130° C., about 100° C. to about 130° C., or about 110° C. to about 130° C.

For example, the at least two films can be stretched of about 20% to about 75% at the first temperature and the at least two films can be stretched of about 40 to about 200% at the second temperature.

For example, the at least two films can be stretched of about 30% to about 70% at the first temperature and the at least two films can be stretched of about 50 to about 175% at the second temperature.

For example, wherein the at least two films can be stretched of about 30% to about 40% at the first temperature and the at least two films can be stretched of about 50 to about 60% at the second temperature.

For example, wherein the at least two films can be stretched of about 50% to about 60% at the first temperature and the at least two films can be stretched of about 70 to about 80% at the second temperature.

For example, the multilayer membrane can comprise three films, the multilayer membranes comprising, in the following order, a first linear polypropylene layer, a high density polyethylene layer, and a second linear polypropylene layer.

1—Effect of Processing on the Crystalline Orientation, Morphology, and Mechanical Properties of Polypropylene Cast Films and Microporous Membrane Formation

### EXPERIMENTAL

### Material

A commercial linear polypropylene (PP5341) supplied by ExxonMobil Company was selected. It had a melt flow rate (MFR) value of 0.8 g/10 min (under ASTM conditions of 230° C. and 2.16 kg) Its molecular weight was estimated from the relationship between the zero-shear viscosity and the molecular weight [10] and found to be around 772 kg/mol. The resin showed a polydispersity index (PDI) of 2.7, as measured using a GPC (Viscotek model 350) at 140° C. and 1,2,4-Trichlorobenzene (TCB) as a solvent. Its melting point, Tₘ, and crystallization temperature, T_{c}, obtained from differential scanning calorimetry at a rate of 10° C./min, were 161° C. and 118° C., respectively.

### Film and Membrane Preparation

The cast films were prepared using an industrial multilayer cast film unit from Davis Standard Company (Pawcatuck, Conn.) equipped with a 2.8 mm thick and 122 cm width slit die and two cooling drums. The extrusion was carried out at 220° C. and the distance between the die exit to the nip roll was 15 cm. The die temperature was set at 220° C. and draw ratios of 60, 75, and 90 were applied. An air knife with dimensions of 3 mm opening and 130 cm width was mounted close to the die to provide air to the film surface right at the exit of the die. The variables of interest were chill roll temperature, amount of air flow, and draw ratio. The films were produced under chill roll temperatures of 120, 110, 100, 80, 50, and 25° C. For all the cast roll temperatures, the air cooling rates used were 0, 1.2, 7.0, and 12 L/s. These air cooling conditions are noted as: no air flow rate (N-AFR), low air flow rate (L-AFR), medium air flow rate (M-AFR), and high air flow rate (H-AFR), respectively.

For membrane fabrication, the precursor films with a thickness, width and length of 35 μm, 46, and 64 mm, respectively, were used. The films were first annealed at 140° C. for 30 min and then cold and hot stretched at 25° C. and 120° C., respectively. Both annealing and stretching were performed using an Instron machine equipped with an environmental chamber. A drawing speed of 50 mm/min was applied during cold and hot stretching steps. The details for the fabrication of the microporous membranes can be found elsewhere [9].

### Film and Membrane Preparation

Fourier transform infrared spectroscopy (FTIR): For FTIR measurements, a Nicolet Magna 860 FTIR instrument from Thermo Electron Corp. (DTGS detector, resolution 2 cm⁻¹, accumulation of 128 scans) was used. The beam was polarized by means of a Spectra-Tech zinc selenide wire grid polarizer from Thermo Electron Corp. The measurement is based on the absorption of infrared light at certain frequencies corresponding to the vibration modes of atomic groups present within the molecule. In addition, if a specific vibration is attributed to a specific phase, the orientation within that phase can be determined [11]. If the films are oriented, the absorption of plane-polarized radiation by a vibration in two orthogonal directions, specifically parallel and perpendicular to a reference axis (MD), should be different. The ratio of these two absorption values is defined as the dichroic ratio, D [11]:

$$D = \frac{{A}_{0}}{{A}_{⊥}} \qquad ( 1 )$$

where [symbol] is the absorption parallel A_{⊥} is the absorption perpendicular to a specific reference axis. The Herman orientation function of this vibration is obtained according to [11]:

$$f = \frac{D - 1}{D + 2} \qquad ( 2 )$$

For polypropylene, absorption at the wavenumber of 998 cm⁻¹ is attributed to the crystalline phase (c-axis) while absorption at the wavenumber of 972 cm⁻¹ is due to the contribution of both crystalline and amorphous phases. From the former absorption, the orientation of the crystalline phase, f_{c}, can be determined while from the latter, the average orientation function, ƒₐᵥ, is obtained. The orientation of the amorphous phase, fₐₘ, can be calculated according to:

ƒₐᵥ=X_{c}f_{c}+(1−X_{c})fₐₘ (3)

where X_{c} is the degree of the crystallinity. Using FTIR, the global, crystalline and amorphous orientations can be determined.

X-Ray Diffraction

XRD measurement was carried out using a Bruker AXS X-ray goniometer equipped with a Hi-STAR two-dimensional area detector. The generator was set up at 40 kV and 40 mA and the copper CuKα radiation (λ=1.542 A°) was selected using a graphite crystal monochromator. The sample to detector distance was fixed at 9.2 cm for wide angle diffraction and 28.2 cm for small angle X-ray scattering analysis. To get the maximum diffraction intensity several film layers were stacked together to obtain the total thickness of about 2 mm.

Wide angle X-ray diffraction (WAXD) is based on the diffraction of a monochromatic X-ray beam by the crystallographic planes (hkl) of the polymer crystalline phase. Using a pole figure accessory, the intensity of the diffracted radiation for a given hkl plane is measured as the sample is rotated through all possible spherical angles with respect to the beam. This gives the probability distribution of the orientation of the normal to hkl plane with respect to the directions of the sample.

The Herman orientation function of a crystalline axis is given by [12]:

$$f = \frac{( 3 {cos}^{2} φ - 1 )}{2} \qquad ( 4 )$$

where φ is the angle between the unit cell axes (a, b, and c) and reference axes. Details about the calculations can be found elsewhere [12].

The orientation factors from WAXD are mainly due to the crystalline part, therefore no information about the orientation of the amorphous phase can be obtained. Small angle X-ray scattering (SAXS) was used to compare the level of the lamellae formation for the different samples and to estimate the long period between lamellae.

Thermal Analysis

Thermal properties of specimens were analyzed using a TA instrument differential scanning calorimeter (DSC) Q 1000. The thermal behavior of films was obtained by heating from 50 to 220° C. at a heating rate of 10° C./min. The reported crystallinity results were obtained using a heat of fusion of 209 J/g for fully crystalline polypropylene (PP) [13].

Mechanical and Tear Analysis

Tensile tests were performed using an Instron 5500R machine equipped with an environmental chamber for tests at high temperature. The procedure used was based on the D638-02a ASTM standard. A standard test method for the tear resistance of plastic films based on ASTM D1922 was used to obtain the MD and TD tear resistances. According to this standard, the work required in tearing is measured by the loss of energy of the encoder, which measures the angular position of the pendulum during the tearing operation.

Morphology

To clearly observe the crystal arrangement of the PP cast films, an etching method was employed to remove the amorphous part. The PP films were dissolved in a 0.7% solution of potassium permanganate in a mixture of 35 volume percentage of orthophosphoric and 65 volume percentage of sulfuric acid. The potassium permanganate was slowly added to the sulfuric acid under rapid agitation. At the end of the reaction time, the samples were washed as described in Olley and Bassett [14].

A field emission scanning electron microscope (FESEM—Hitachi S4700) was employed for the observation of the etched films surfaces as well as microporous membranes. This microscope provides high resolution of 2.5 nm at a low accelerating voltage of 1 kV and high resolution of 1.5 nm at 15 kV with magnification from 20× to 500 kx.

Water Vapor Transmission

The permeability to water vapor was measured via a MOCON PERMATRAN-W Model 101K at room temperature. It is composed of three chambers: an upper chamber containing liquid water and separated from the center chamber by two porous films. Water vapor diffuses from the first film to fill the space between the films to reach 100% relative humidity (RH). The center chamber is separated from the lower one by the test film. The diffused vapor is swept away by N₂ gas to a relative humidity (RH) sensor.

Rheological Characterization

Dynamic rheological measurements were carried out using a Rheometric Scientific SR5000 stress controlled rheometer with a parallel plate geometry of 25 mm diameter and a gap equal to 1.5 mm at the temperatures of 180, 195, 210, and 225° C. under nitrogen atmosphere. Molded discs of 2 mm thick and 25 mm in diameter were prepared using a hydraulic press at 190° C. Prior to frequency sweep tests, time sweep tests at a frequency of 0.628 rad/s and different temperatures were performed for two hours to check the thermal stability of the specimens. No degradation (less than 3% changes) was observed at test temperatures for the duration of the frequency sweep measurements. The dynamic data were obtained in the linear regime and used to evaluate the weighted relaxation spectra of the samples.

### Results and Discussion

Experimental data that clearly demonstrate the effects of process conditions are firstly shown. More particularly, air cooling and drum temperature, on crystallization, orientation of the amorphous and crystalline phases, and also tear and mechanical properties. Subsequently, two morphological pictograms are proposed to describe the observed experimental data and the reasons for these observations are discussed. Finally, the structure and properties of the microporous membranes obtained from the PP cast films having different microstructures are presented.

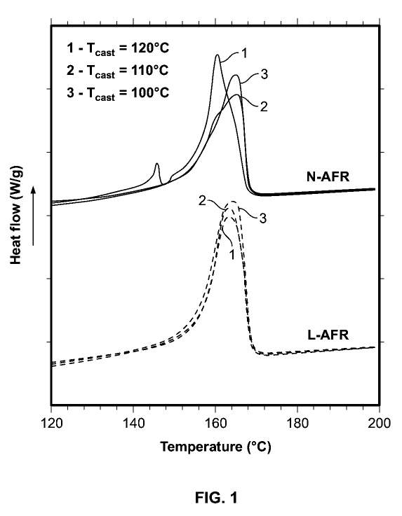

The effects of cast roll temperature (T_{cast}) and air cooling on thermal behavior of the films were examined using differential scanning calorimetry (DSC) and the results are shown in FIG. 1. The top curves in this figure exhibit the thermograms of the films prepared at the chill roll temperatures of 100, 110, and 120° C. without air cooling. For these films, melting peaks around 163, 162, and 156° C. are observed, respectively. However, for the sample obtained at the drum temperature of 120° C. and no air flow rate condition (N-AFR) an additional peak at 144° C. is observed. Also for the sample obtained at the cast roll temperature of 110° C. a small shoulder at 156° C. is seen. These suggest the presence of a bimodal crystal (either lamellae or spherulite) size distribution (the WAXD measurements for these specimens showed no intensity peaks corresponding to the beta crystal form; therefore, the presence of this type of crystals is excluded). Both the additional peak and shoulder disappeared when T_{cast} was set at 100° C. or less (not shown). The thermograms of the films subjected to a small amount of air flow at different T_{cast} (bottom curves in FIG. 1) show narrower melting curves without any additional peak or shoulder. These indicate a more uniform crystal size structure for the films prepared at L-AFR condition.

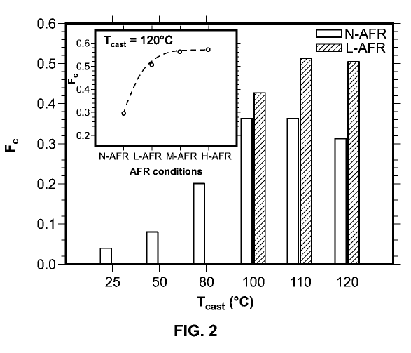

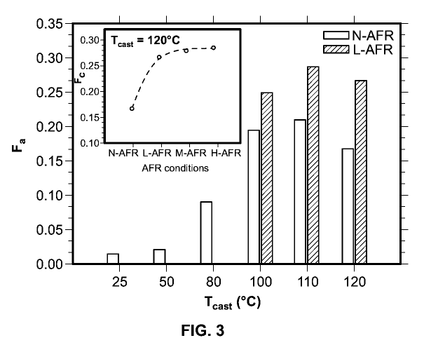

The orientation and arrangement of the crystal lamellae in the cast films are influencing factors in controlling the final properties of manufactured films. FIGS. 2 and 3 present the Herman orientation functions of the crystalline phase as well as of the amorphous phase obtained from FTIR, respectively. For the N-AFR condition, it is obvious that decreasing T_{cast} reduces the orientation of both the crystalline and amorphous phases (FIGS. 2 and 3). For no air flow (N-AFR) and very low T_{cast}, quenching of the polymeric film happens and as a consequence a spherulitic crystal structure is expected, which leads to quite low crystal alignment. However, by increasing the drum temperature, the film temperature gets close to the crystallization point, T_{c}, of the resin; thus the molecules have more chance to crystallize in the extended configuration created under high draw ratio. This results in films with higher crystal orientation. Moreover, compared to the no air cooled films, significant improvement in the orientation of the crystalline and amorphous phases is observed when the film surface is exposed to a small amount of air cooling (FIGS. 2 and 3). For the samples obtained under air cooling and at a drum temperature of 80° C. and lower, the orientations (not shown) were close to the one at T_{cast} of 100° C. and the reasons for that will be explained later. The insets in FIGS. 2 and 3 reveal the Herman orientation functions of the crystalline and amorphous phases of the samples obtained at T_{cast} of 120° C. for different air flow rates, respectively. It is clear that applying a small amount of air flow enhances the orientation of the crystalline and amorphous phases drastically while further increases in air flow do not significantly affect them.

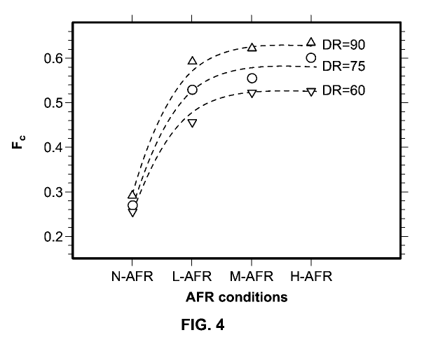

The effect of the amount of applied strain, either in shear or elongational flow, on the lamellar structure of the various resins has been investigated recently [7, 15-17]. The authors reported that as the level of strain increased, more lamellae accompanied with better orientation were generated. The influence of draw ratio on the orientation of the crystalline and amorphous phases has also been considered [9, 17, 18]. In the cast film process of PP, an almost linear relationship between the draw ratio and the orientation factor was reported [9, 18]. At low draw ratios, the lamellae were not well aligned perpendicular to the flow direction, but at high draw ratios, the lamellae aligned themselves perpendicular to the machine direction, resulting in higher orientation. In this study, the influence of the draw ratio on the orientation function with and without the use of air flow is illustrated in FIG. 4 for draw ratios of 60, 75, and 90. Obviously, compared to the no air cooled films and for all the draw ratios, a jump in the orientation parameter is seen by the use of low air cooling. In addition, the draw ratio has a stronger effect on the orientation function for the films subjected to air cooling.

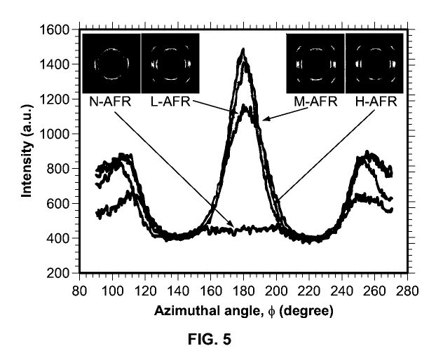

The effect of air cooling on orientation of the crystalline phase was also considered using WAXD, as shown in FIG. 5. In the WAXD patterns, the first and second rings represent the patterns for the 110 and 040 crystalline planes, respectively [12]. A diffraction ring is seen for the 110 crystallographic plane for the no air cooled film, indicating a low crystalline phase orientation. However, instead of rings, arcs that are sharper and more concentrated in the center are observed for the air cooled samples, implying more orientation. This behavior can be better shown when the intensity is plotted as a function of the azimuthal angle. The azimuthal angle, φ, is 0 or 180° along the equator and 90 or 270° along the meridian. For each φ, the average intensity at 2θ(=12.6°±0.17° of the 110 plane was extracted from the 2D WAXD patterns and the results for the samples produced under different air flow rates are plotted in FIG. 5. Noticeable jumps at azimuthal angles around 180° as well as about 90° and 270° are observed when a small amount of air blowing is applied while further increases in the air flow rate do not dramatically impact the azimuthal intensity profile. The much sharper peaks for the air cooled films indicate a higher orientation of the crystal lamellae compared to the no air cooled ones.

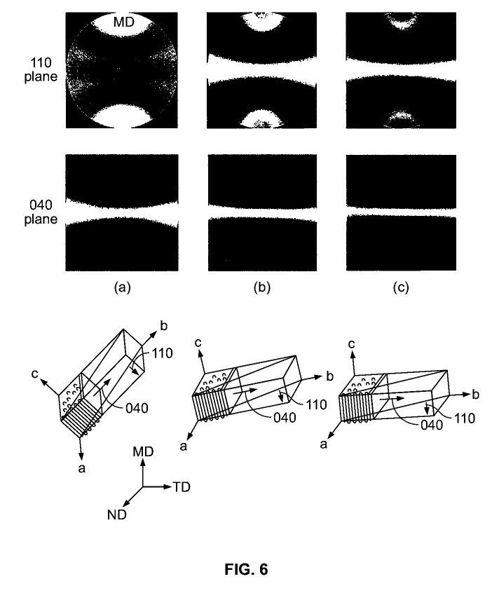

The crystalline orientation can also be analyzed quantitatively from the pole figures of the 110 and 040 planes, as illustrated in FIG. 6. The normal to the 110 plane is the bisector of the a and b axes and the 040 plane is along the b-axis of unit crystal cells [12]. For the film obtained without air cooling, slight orientations of the 110 and 040 planes are detected in MD and TD, respectively. However, for the film produced at L-AFR a significant orientation of the 110 plane is observed along TD and that of the 040 plane (b-axis) is in both TD and ND. The pole figures for the samples obtained at higher air flow rates (i.e. M-AFR and H-AFR) were similar to L-AFR with slightly higher orientation intensities. The schematics in FIG. 6 represent the crystal alignments based on their pole figures.

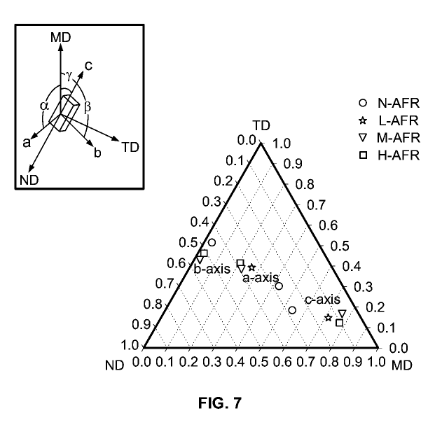

The orientation features, in terms of cos² (φ) of the crystalline axes (i.e. a, b, and c (see the sketch in FIG. 7)) along MD, TD, and ND obtained from the Herman orientation function for the no air cooled as well as the air cooled films casted at the chill roll temperature of 120° C. are presented in the triangular plot of FIG. 7. It is obvious that a small amount of cooling causes a large shift of the c-axis of the crystals towards the MD, while a- and b-axes take a position closer to the TD and ND planes. This clearly shows that air cooling enhances the orientation of the films, in accordance with the FTIR data. It should be mentioned that the orientation functions obtained using FTIR were slightly larger than the values from the WAXD pole figure. The discrepancies in the values of the measured c-axis orientation may be due to different factors such as peak deconvolution, contribution of the amorphous phase etc., as discussed for PE and PP elsewhere [1, 19].

The degree of crystallinity (X_{c}) of the samples determined using WAXD and DSC is presented in Table 1. In WAXD, the contributions arising from the crystalline and amorphous parts were extracted via peak fitting of the 28 diffraction pattern. Similarly to DSC results, it was observed that cooling improves crystallinity. However, the crystallinity obtained from WAXD was slightly higher than that from DSC. In addition, the average crystal width in the directions of the 110 and 040 crystallographic planes were determined from the full width at half maximum Δ(2θ) of the deconvoluted diffraction profiles according to the following equation [20]:

$${D}_{h \text{/} k} = \frac{K λ}{Δ ( 2 θ ) cos θ} \qquad ( 5 )$$

where K is a crystallite form coefficient that is taken equal to 1 and λ is the X-ray wavelength. Although it is known that this equation is not accurate because it neglects the broadening due to the lattice distortions, it allows a useful comparison of the crystalline structures for the various films. Table 1 also presents the variations of the D₁₁₀ and D₀₄₀ with air cooling for the films casted at 120° C. Both D₁₁₀ and D₀₄₀ are enhanced by the use of low air cooling and do not vary by further increases of air flow. The D₀₄₀ crystallite size corresponds to an average size of the crystallites that are oriented parallel to the film plane. Therefore, the increase of D₀₄₀ suggests that the crystallite size is increased in a direction parallel to the b crystallographic axis. The effect of the cast roll temperature on the D₀₄₀ was also evaluated (not shown here) and no noticeable impacts were found.

TABLE 1
Crystal characteristics of the cast films obtained under
different air cooling rates; DR = 75.

| | FWHM | D₁₁₀ | FWHM | D₀₄₀ | X_{c} | X_{c} |
|---|---|---|---|---|---|---|
| | (110) | A° | (040) | A° | (XRD) | (DSC) |
| T_{cast} = 120° C., | 1.24 | 72 | 1.06 | 84 | 42.2 | 42.2 |
| N-AFR | | | | | | |
| T_{cast} = 120° C., | 1.14 | 78 | 0.86 | 103 | 44.3 | 43.2 |
| L-AFR | | | | | | |
| T_{cast} = 120° C., | 1.13 | 79 | 0.87 | 102 | 45.7 | 44.4 |
| M-AFR | | | | | | |
| T_{cast} = 120° C., | 1.12 | 80 | 0.87 | 102 | 46.1 | 44.6 |
| H-AFR | | | | | | |

trates the SAXS patterns as well as the azimuthal intensity profile for the films obtained under different air cooling rates. The equatorial streak in the SAXS patterns is attributed to the formation of the shish, while the meridian maxima are attributed to the lateral lamellae or kebabs [6]. Looking at the meridian intensity (either pattern or azimuthal profile), the formation of more lamellae for the air cooled samples is obvious. In addition, for all conditions, it is clear that the contribution of the shish to the crystalline phase is much less than that of lamellae, confirming the results of Somani et al. [21] for PE and PP.

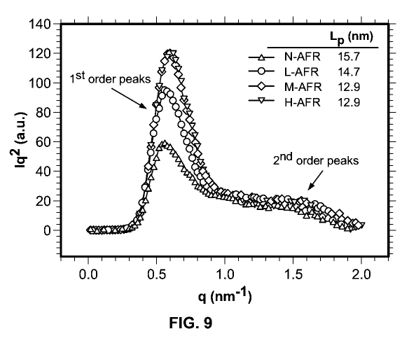

The long period distance, Lₚ, was estimated from the position of the Lorentz corrected intensity maxima, as demonstrated in FIG. 9 (Lₚ=2π/qₘₐₓ where q is the intensity vector, q=4π sin θ/λ).

A first order peak arising from stacks of parallel lamellae and a second order peak indicating that the periodicity of the lamellae is high [22] is observed. Air cooling slightly shifts the peaks to higher values, indicating a decrease of the long period spacing. Long period spacing results for the no air cooled as well as the air cooled specimens are also reported in FIG. 9. The value of Lₚ for the films subjected to air cooling is smaller than that for the films produced without applying air cooling (Lₚ=14.7 nm compared to 15.7 nm) and decreases with increasing AFR. As all films were produced under the same draw ratio, the decrease of Lₚ is attributed to the formation of more lamellae and consequently a more compact structure, which reduces the distance between lamellae.

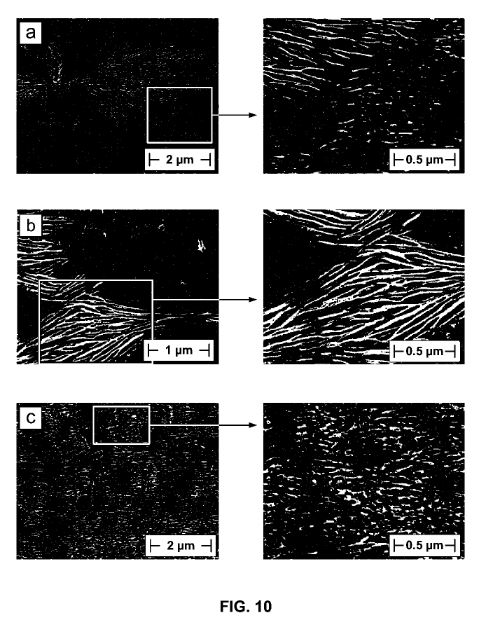

The previous results imply that an oriented shish-kebab crystal structure is obtained by the use of air cooling in addition to the chill roll, compared to a much less ordered crystal structure for the no air cooled films. These differences can be clearly visualized from SEM surface images of the etched films (etching removes the amorphous region), as demonstrated in FIG. 10. FIG. 10a shows the micrograph of the surface of the film obtained without employing air cooling and at T_{cast} of 120° C. For such conditions, spherulites, small rows of lamellae, and some cross-hatched crystalline structures coexist. The size of the spherulites is much larger than the lamellae, whereas the lamellae have been oriented somehow perpendicular to MD. The rectangle in FIG. 10a illustrates the interface of a spherulite and rows of lamellae and its higher magnification image is shown on the right. More spherulites and lamellar branching are observed for the films prepared at T_{cast} of 110° C. and without the use of air cooling (FIG. 10b). The lamellar branching from the primary lamellae is produced by epitaxial growth due to cross-hatched lamellar texture, which is a unique characteristic of PP crystalline structure [1]. The rectangle in FIG. 10b exhibits the impingement of spherulites, clearly demonstrated by its higher magnification micrograph on the right. For the no air cooling condition, the number of spherulites increased and the cross-hatched morphology became more random (balanced) (not shown) as the cast roll temperature changed from 100° C. to 25° C. This can be explained by the quenching effect (and hence low crystal orientation) of the cast roll at temperatures much lower than T_{c} of the resin. In contrast, a more uniform and ordered stacked lamellar structure is observed for the films subjected to a low air cooling (FIG. 10c), confirming the FTIR and WAXD results (see FIGS. 2 and 7). In FIG. 10c, no spherulites are seen and the sizes of lamellae are much larger than the lamellae shown in FIG. 10a, which is qualitatively in good agreement with the XRD results (see Table 1). The dark spots in FIG. 10c could be due the presence of very small spherulites or some crystalline parts that have been removed by etching. Applying higher air cooling rate slightly improved the orientation and size of lamellae and for that reason the results are not presented here. Additionally, for the L-AFR condition, it was realized that T_{cast} lower than 100° C. did not noticeably influence the structure of the air cooled films, indicating that the crystal structure has been established before contacting the nip roll. In other words, by applying air cooling, the frost line has been formed before the extruded film touches the nip roll. Therefore, high T_{cast} (i.e. T_{cast}=120° C. or 110° C.) affects the structure as annealing does (i.e. removes the imperfection in crystalline phase and slightly increases the crystal size and orientation [8, 18, 23]). This is why the films produced under air cooling and high T_{cast} show slightly higher orientation than the ones obtained at low T_{cast} (i.e. T_{cast}=100° C. or lower).

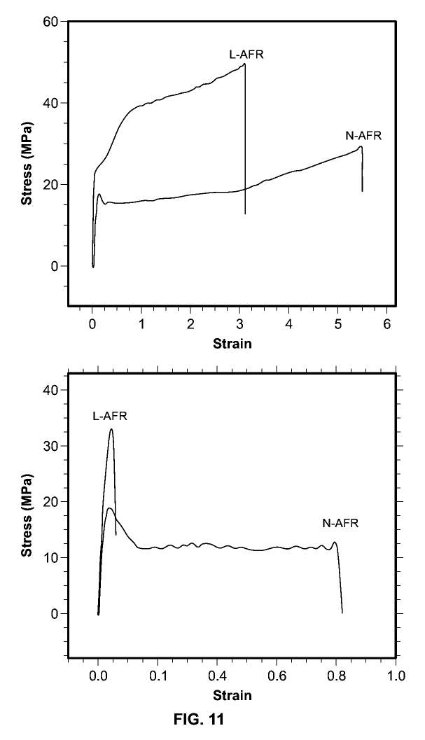

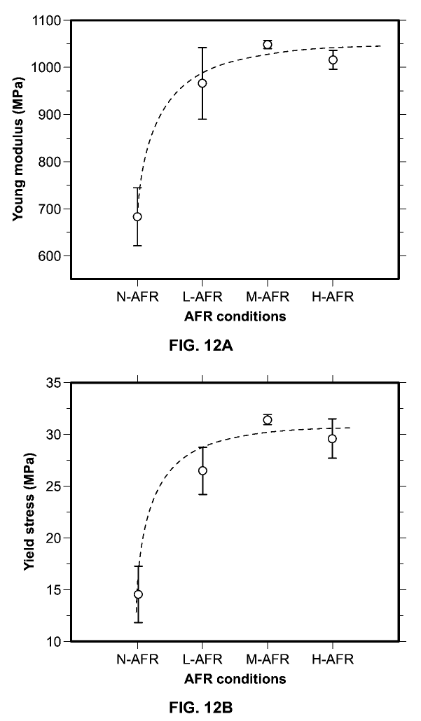

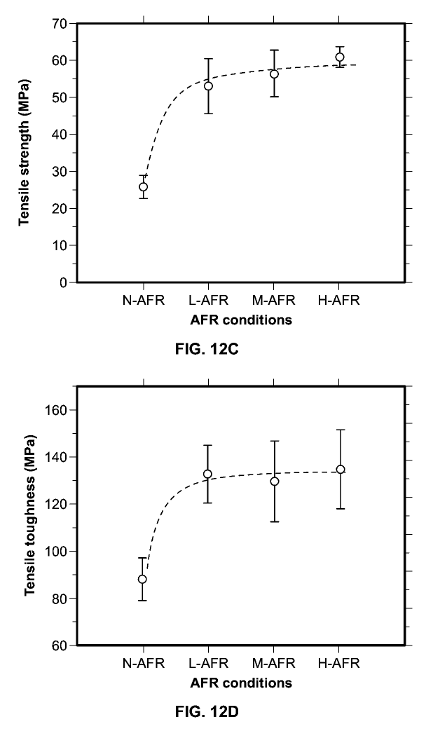

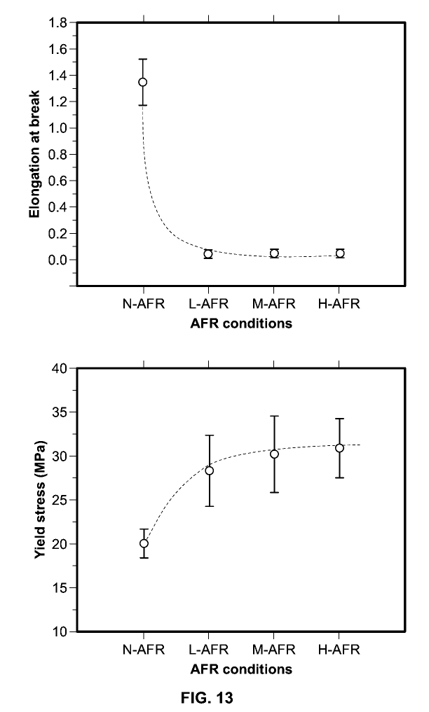

It is well established that the structure of the crystalline and amorphous phases strongly influence the mechanical and tear properties of films. In other words, the mechanical and tear behaviors are closely related to structure changes. Zhang et al. [24] studied the microstructure of LLDPE, LDPE, and HDPE blown films and showed that the type of oriented structure was greatly dependent on the type of polyethylene as well as on the processing conditions. These structure differences were shown to translate into different ratios for MD and TD tear and tensile strengths [24]. FIGS. 11a and 11b show the typical stress-strain behavior (for samples prepared without and with air cooling) along MD and TD, respectively. The stress-strain response for the no air cooled samples along MD exhibits the typical behavior of films of a spherulitic structure with an elastic response at low deformation, yielding and plastic behavior at medium deformation, and strain hardening at high elongation. In contrast, the stress-strain response of the air cooled specimens along MD reflects the typical behavior of films of a lamellar crystalline morphology with an initial elastic response at low deformation followed by two strain hardening zones. An extensive discussion on this behavior can be found in Samuels [25]. To clearly understand the influences of air cooling on the mechanical properties of the manufactured films, the Young modulus, yield stress, tensile strength, tensile toughness along MD, elongation at break, and yield stress along TD for all the films were determined, as depicted in FIGS. 12 and 13, respectively. All properties along MD (FIG. 12) improve significantly as the films are subjected to a low level of AFR. This can be easily explained by the much better alignment of the lamellae due to air cooling. Additionally, it should be pointed out that further increases of AFR do not noticeably change the mechanical properties along MD, which is in agreement with their orientation trend (see FIGS. 2 and 7).

The enhancement of the mechanical response along MD, due to the high orientation of the cooled specimens along MD, was, however, accompanied by significant reductions of the elongation at break along TD (FIG. 13). This anisotropy of the tensile properties along MD and TD was also reported for different PE resins [24] and it was shown that as the level of orientation increased the anisotropy in the mechanical properties increased. FIG. 13 also shows that the yield stress along TD is enhanced as the air flow rate is increased. According to Zhou and Wilkes [26], for HDPE having a stacked lamellar structure, stretching perpendicular to MD caused the crystal lamellae to break up or rupture by chain pull-out. In our case, it is postulated that applying air cooling forms more tie chains between the stacked lamellae, which are possibly responsible for the increase of the yield stress with increasing air flow rate.

Table 2 reports the mechanical properties along MD and TD for the films produced at T_{cast} of 120, 110, 100° C. under N-AFR as well as L-AFR conditions. Compared to the no air cooled films, a significant effect of low air blowing on the mechanical properties, at all drum temperatures, is observed. It is clear that the Young modulus, yield stress, tensile toughness, and tensile strength along MD decrease as T_{cast} decreases. This is due to the formation of more lamellae at higher T_{cast} for the no air subjected films (see FIGS. 10a and 10b) and annealing effect at high T_{cast} for the air subjected films.

TABLE 2
Mechanical properties of the cast films along MD and TD (the numbers in parenthesis
indicate the standard deviation of the measurements); DR = 75.

| | Mechanical properties | | | | | Mechanical properties | |
|---|---|---|---|---|---|---|---|
| | along MD | | | | | along TD | |
| | Young | Yield | Tensile | | Tensile | Yield | |
| | modulus | stress | toughness | Strain | strength | stress | Strain |
| | (MPa) | (MPa) | (MPa) | at break | (MPa) | (MPa) | at break |
| T_{cast} = 120° C., N-AFR | 683.5 (61.8) | 14.5 (2.7) | 93.2 (15.2) | 5.5 (0.0) | 25.7 (3.1) | 20.0 (1.6) | 1.2 (0.4) |
| T_{cast} = 120° C., L-AFR | 967.0 (157.0) | 26.1 (4.8) | 122.7 (25.3) | 2.8 (0.4) | 53.0 (7.2) | 25.7 (6.1) | 0.05 (0.01) |
| T_{cast} = 110° C., N-AFR | 604.4 (51.2) | 12.2 (2.0) | 81.3 (13.6) | 6.2 (0.4) | 21.3 (7.6) | 17.5 (1.3) | 1.5 (0.1) |
| T_{cast} = 110° C., L-AFR | 890.2 (98.3) | 23.5 (3.3) | 106.0 (15.6) | 2.7 (0.1) | 49.2 (2.4) | 25.2 (0.6) | 0.05 (0.01) |
| T_{cast} = 100° C., N-AFR | 562.9 (167.5) | 10.8 (3.1) | 74.6 (15.4) | 6.7 (0.1) | 19.7 (4.3) | 15.9 (0.8) | 1.48 (0.1) |
| T_{cast} = 100° C., L-AFR | 853.8 (19.8) | 22.1 (1.0) | 97.8 (1.8) | 2.4 (0.0) | 46.9 (0.8) | 23.5 (4.9) | 0.05 (0.01) |

It is well understood that tear measurements are very sensitive to the type and alignment of crystalline morphology [24]. Along MD, tear resistance values of 0.178, 0.154, 0.146, and 0.121 g/μm were measured for the films obtained at T_{cast}=120° C. and N-AFR, L-AFR, M-AFR, and H-AFR, respectively: the higher the orientation of the crystalline and amorphous phases, the lower the tear resistance along MD. It was observed that measurements of the tear resistance along TD for samples subjected to air cooling were impossible, because the tearing direction deviated most of the time to MD. In fact, there is a high resistance in TD when compared to MD, which causes a crack in MD and created non-reproducible data that are not reported here. This implies that for air cooled films, a shish-kebab lamellar crystal structure with shishs aligned in MD is formed.

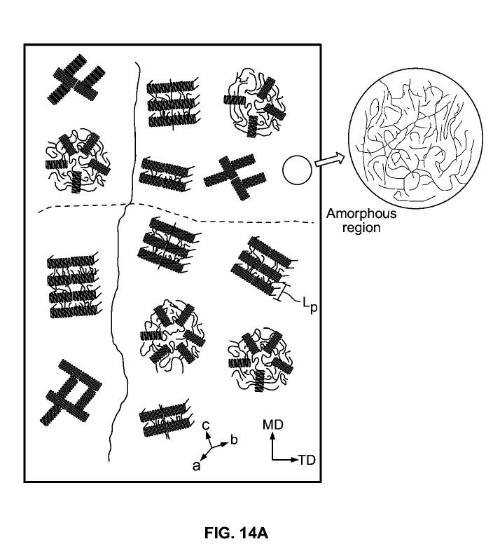

Based on observations from thermal analysis, FTIR results, WAXD and SAXS patterns, microscopy, mechanical and tear properties, two microstructural pictograms (one for the no air cooled cast film and another for the cast films produced with the use of air cooling) are proposed as depicted in FIG. 14.

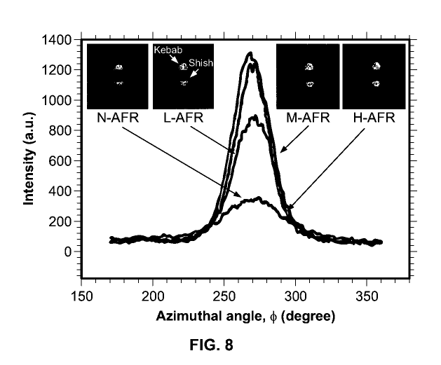

For the films produced at high chill roll temperatures and without air cooling, FTIR data, WAXD and SAXS patterns suggest the presence of a lamellar crystalline structure (rows of lamellae and/or cross-hatched), which is not preferentially oriented in MD (see FIGS. 2, 7, and 8). Additionally, the facility of tearing these samples along TD indicates that the shishs are not long. However, for these samples, the stress-strain behavior along MD and TD implies the presence of a spherulitic crystalline structure as well. Therefore, as illustrated in FIG. 14a, for the films produced without air cooling and at high T_{cast}, it is believed that spherulitic, row nucleated, and cross-hatched lamellar crystalline structures coexist as confirmed by the SEM micrographs of FIGS. 6.10a and b. In FIG. 14a, the solid line represents the tear path for the sample torn in MD, whereas the dash line reflects the tear path for the one torn in TD. The cast films having this mixed structure can be easily torn along both MD and TD. At low cast roll temperatures (i.e. at temperatures far below T_{c} of the resin), low orientation values for both crystalline and amorphous phases were determined (see FIGS. 2 and 3), indicating the formation of more spherulitic and randomly cross-hatched crystal forms.

In contrast, for the films produced under air cooling, FTIR data, SAXS and WAXD patterns suggest the presence of a stacked lamellar crystal structure, which is preferentially oriented into MD (see FIGS. 2 and 7). In addition, the impossibility to tear these samples along TD suggests that the size of the shish is much larger in comparison with those for the films casted under N-AFR. Furthermore, a very low elongation at break along TD for the films subjected to air cooling is an indication that the spherulitic crystalline structure does not exist or is present in a very small quantity. This is confirmed by the SEM results shown in FIG. 10c. Hence, as depicted in FIG. 14b, a uniform shish-kebab structure for the films produced under air cooling is expected. The cast films having this structure can be easily torn along MD. However, as sketched in FIG. 14b, because of the presence of the long shishs, tearing along TD is impossible and the tearing direction always deviates to MD. As described before, under air cooling conditions, the variation of T_{cast} does not noticeably affect the shish-kebab structure.

Based on FTIR results for the orientation of the amorphous phase (see FIG. 3), circles in FIGS. 14a and 14b also reveal the proposed structure for the amorphous region of films made without and upon air cooling, respectively. By applying air cooling, the extruded film temperature at the die exit decreases and, as a consequence, the applied stress on the polymer chains increases. This yields some local organization in the amorphous phase, which is responsible for its higher orientation.

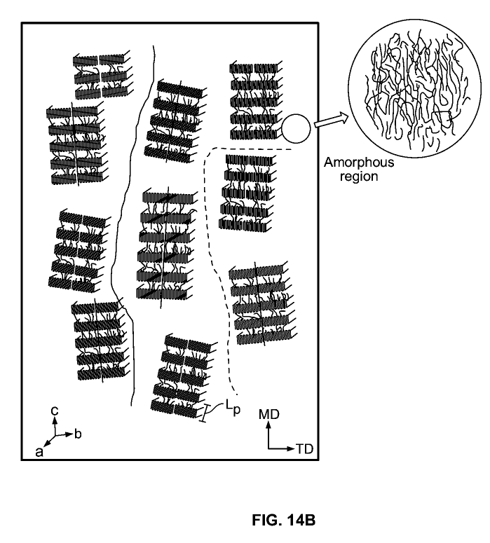

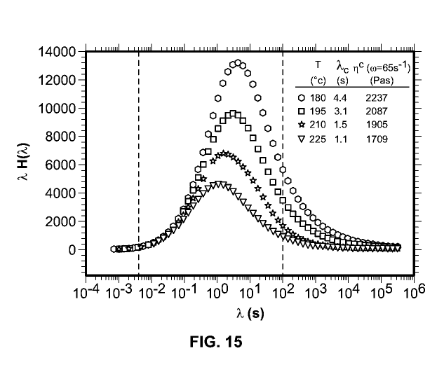

In the following section, justifications regarding the roles of air cooling and drum temperature on the final crystal microstructures are presented. The orientation and morphological differences are believed to originate from the rheological characteristics and crystallization kinetics. It is well known that temperature has an effect on the relaxation time of polymer chains as well as on the crystallization rate. In order to consider the effects of temperature on the applied stress and relaxation time of the molecules, linear dynamic rheological measurements were carried out. FIG. 15 reports the weighted relaxation spectra for different melt temperatures using the NLREG (non linear regularization) software [27] (the vertical dash lines represent the range of frequencies covered during the experiments). It is considered that the characteristic relaxation time, λ_{c}, corresponding to the peak of the curves. From FIG. 15, as temperature is decreased a longer relaxation time is observed (see the legend in figure). Assuming a linear velocity profile for the melt film between the die exit and cast roll nip and also assuming pure uniaxial flow in this region, the effective deformation rate based on the second invariant of the rate-of-deformation tensor was estimated to be around 65 s⁻¹. The complex shear viscosities at 65 s⁻¹ and for different temperatures were taken as estimates of the melt viscosity and their values are reported in the legend of FIG. 15. Obviously, the lower the temperature the larger the viscosity, and consequently the higher the applied stress. Hence, as air cooling is used, the melt temperature right at the exit of the die decreases and, as a consequence, the applied stress (or relaxation time) rises drastically. This promotes the number of shishs or nuclei sites, resulting in a noticeable increase of the probability for the formation of lamellae by the low molecular weight chains.

In general, the rate of crystallization is first controlled by nucleation and then by the growth and packing of the crystals [28]. In our case, the air cooling causes a large decrease in the extruded film temperature such that crystallization temperature of the resin is reached before the frost line is formed. This increases the number of nuclei sites resulting in a much faster crystallization rate. This fact, together with the intrinsic temperature effects on the relaxation time, as discussed above, determines a significant coupling between temperature and flow, yielding to a novel highly oriented lamellar structure. In other words, the use of air cooling in addition to chill rolls in the cast film process helps flow induced crystallization to occur at lower temperatures. This will noticeably increase the number of shish or nuclei sites, and consequently the crystallization kinetics is promoted resulting in a well oriented shish-kebab structure.

To produce microporous membranes by the stretching technique, precursor films with an adequate orientation and alignment of the crystal lamellae are needed [9, 18]. In this study, the effects of microstructure differences of the PP cast films on the microporous membranes morphology and water vapor transmission rate were investigated. Three consecutive stages were carried out to obtain porous membranes: cast or precursor film formation, annealing, and stretching in two steps (cold and hot). During cold stretching, the pores were created whereas in the subsequent hot stretching they were enlarged. WAXD and FTIR measurements clearly showed that cooling drastically enhanced orientation of crystal lamellae in the precursor films; hence, a microporous membrane with more pore density and better tortuosity is expected as air cooling is utilized.

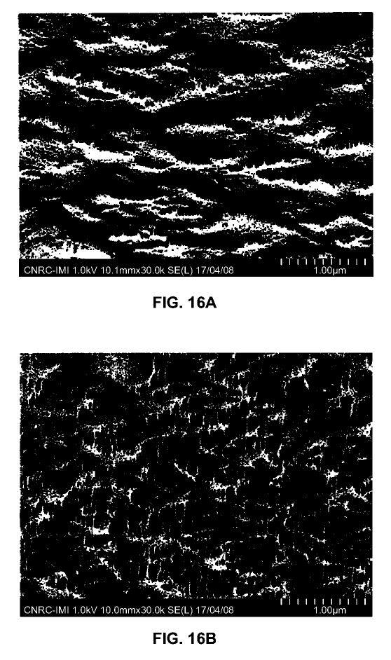

FIG. 16 presents SEM micrographs of the surface of the fabricated membranes. Very thick lamellae, non uniform pores and a small amount of pores for the porous membrane obtained from the no air cooled film is observed (FIG. 16a). However, for the membrane prepared from the cast film subjected to a small air cooling rate, the number of pores noticeably increase and more uniform pore sizes and a better morphology are observed as well (FIG. 16b). Note more and thinner lamellae appear for the latter compared to the former, supporting the previous results.

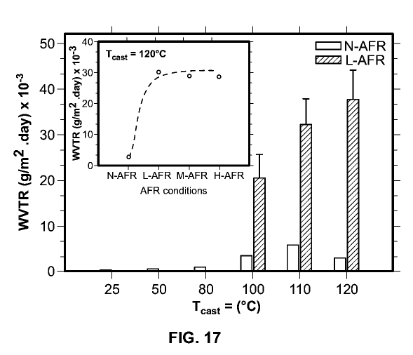

FIG. 17 presents the water vapor transmission rates (WVTR) of the produced microporous membranes. Small WVTR were recorded for the no air cooled samples produced at different cast roll temperatures. However, interestingly, the WVTR increased by a factor of 20 when the film surface was subjected to a low air flow, which is attributed to the formation of more pores, higher porosity, and better interconnection between the pores. Compared to the sample prepared at L-AFR, further increases of the air cooling rate (i.e. at M-AFR and H-AFR), did not significantly increase the permeability was (see the inset of FIG. 17), indicating that more air cooling does not dramatically influence the lamellar structure, in accordance with the previous results (see FIGS. 2 to 8).

In view of the above, it can thus be said that:
In the cast film process, air cooling and cast roll temperature have a role on the orientation of the crystalline as well as the amorphous phases.
Increasing the draw ratio increased the crystal orientation (F_{c}), and a stronger effect of the draw ratio on F_{c} was observed by applying air cooling.
The use of a low air cooling rate contributed significantly to the perfection of the crystalline phase, while further increasing of air cooling did not noticeably affect the crystal structure.
Significant increases of the Young modulus, yield stress, tensile strength, and tensile toughness along MD, and dramatic decreases of elongation at break along TD were observed as air cooling was applied. These were explained by a better molecular and crystal orientation for air cooled cast films.
For films produced without air cooling and at high roll temperature, coexisting lamellae and spherulites were observed. In contrast, an ordered stacked lamellar structure was seen for the films subjected to a low air cooling.
Better orientations of the crystalline and amorphous phases for the air cooled films were attributed to the larger relaxation time and faster flow induced crystallization. Applying air cooling in addition to the use of cast rolls helped flow induced crystallization to occur at lower temperatures. This noticeably increased the crystallization kinetics, resulting in a well oriented shish-kebab structure.
Microporous membranes having high pore density, large porosity, and high water vapor permeability were obtained by lamellae separation for cast films prepared using air cooling.
   2—Microporous Membranes Obtained from Polypropylene Blend Films by Stretching

### Materials

Two commercial linear polypropylenes (PP28, PP08) were selected. Both PPs were supplied by ExxonMobil Company and had MFR values of 2.8 g/10 min (under ASTM conditions of 230° C. and 2.16 kg) and 0.8 g/10 min, respectively. The main characteristics of the resins are shown in Table 3. The molecular weight of the linear PPs was evaluated using the relation between the zero-shear viscosity and the molecular weight [39]. The melting point, Tₘ, and the crystallization temperature, T_{c}, of the resins were obtained using differential scanning calorimetry. For the rheological characterization, blends containing 2, 5, 10, 30, 50, and 70 wt % PP08 were prepared using a twin screw extruder (Leistritz Model ZSE 18HP co-rotating twin screw extruder) followed by water cooling and pelletizing. The temperature profile along the barrel was set at 160/180/190/200/200/200/200° C. The extrusion was carried out at 80 rpm. During blending, 3000 ppm of a stabilizer, Irganox B225, was added to avoid thermal degradation of the polymers. To make sure that all samples have the same thermal and mechanical history, unblended components were extruded under the same conditions.

TABLE 3
Main characteristics of neat polymers.

| | | | No- | | | | |
|---|---|---|---|---|---|---|---|
| | | MFR | men- | | M_{w} | | |
| Resin | | 230° C./ | cla- | ηₒ | (kg/ | Tₘ | T_{c} |
| code | Company | 2.16 kg | ture | (Pa · s) | mol) | (° C.) | (° C.) |
| PP4712 | ExxonMobil | 2.8 | PP28 | 12500 | 543 | 160 | 115 |
| PP5341 | ExxonMobil | 0.8 | PP08 | 41600 | 772 | 160 | 117 |

### Rheological Characterization

Dynamic rheological measurements were carried out using a Rheometric Scientific SR5000 stress controlled rheometer with a parallel plate geometry of 25 mm diameter and a gap equal to 1.5 mm at the temperature of 190° C. under nitrogen atmosphere. Molded discs of 2 mm thick and 0.25 mm in diameter were prepared using a hydraulic press at 190° C. Time sweep test was first performed at a frequency of 0.628 rad/s for two hours. Material functions such as complex viscosity, elastic modulus, and weighted relaxation spectrum in the linear viscoelastic regime were determined in the frequency range from 0.01 to 500 rad/s. In order to obtain more accurate data, the frequency sweep test was carried out in four sequences while the amount of applied stress in each sequence was determined by a stress sweep test.

### Film and Membrane Preparation

The precursor films from PP28 and blends containing 2, 5, 10, and 20 wt % PP08 were prepared by extrusion using a slit die of 1.9 mm thick and 200 mm width. An air knife was mounted on the die to supply air to the film surface right at the exit of the die. The main parameters were die temperature, cooling rate, and draw ratio (ratio of the roll speed to the die exit velocity) [7]. In this study the die temperature was set at 220° C. and the maximum speed of the fan was applied, thus the only variable was the draw ratio. The film samples were prepared under draw ratios of 70, 80, and 90.

For membrane preparation, precursor films having a thickness, width and length of 35 μm, 46 mm and 64 mm, respectively, were used. Both annealing and stretching were performed using an Instron machine equipped with an environmental chamber. A drawing speed of 50 mm/min was applied during the cold and hot stretching steps.

### Film and Membrane Characterization

Fourier transform infrared spectroscopy (FTIR): For FTIR measurements, a Nicolet Magna 860 FTIR instrument from Thermo Electron Corp. (DTGS detector, resolution 4 cm⁻¹, accumulation of 128 scans) was used. The measurement is based on the absorption of infrared light at certain frequencies corresponding to the vibration modes of atomic groups present within the molecule. In addition, if a specific vibration is attributed to a specific phase, the orientation within that phase can be determined [36]. If the films are oriented, the absorption of plane-polarized radiation by a vibration in two orthogonal directions, specifically parallel and perpendicular to a reference axis (MD), should be unequal. The ratio of these two absorption values is defined as

the dichroic ratio, D [40]:

$$D = \frac{{A}_{0}}{{A}_{⊥}} \qquad ( 6 )$$

where [symbol] is the absorption parallel and A_{⊥} is the absorption perpendicular to a specific reference axis. The Herman orientation function of this vibration is obtained according to [40]:

$$f = \frac{D - 1}{D + 2} \qquad ( 7 )$$

For polypropylenes, absorption at the wavelength of 998 cm⁻¹ is attributed to the crystalline phase (c-axis) while absorption at the wavelength of 972 cm⁻¹ is due to the contribution of both crystalline and amorphous phases. From the former absorption, the orientation of the crystalline phase, f_{c}, can be determined while from the latter, the average orientation function, ƒₐᵥ, is obtained. The orientation of the amorphous phase, fₐₘ, can be calculated according to:

fₐᵥ=X_{c}f_{c}+(1−X_{c})fₐₘ (8)

where X_{c} is the degree of the crystallinity. Using FTIR, the global, crystalline and amorphous orientations can be determined.

X-Ray Diffraction

XRD measurement was carried out using a Bruker AXS X-ray goniometer equipped with a Hi-STAR two-dimensional area detector. The generator was set up at 40 kV and 40 mA and the copper Cu Kα radiation (λ=1.542 A°) was selected using a graphite crystal monochromator. The sample to detector distance was fixed at 9.2 cm for wide angle diffraction and 28.2 cm for small angle x-ray scattering analysis. To get the maximum diffraction intensity several film layers were stacked together to obtain the total thickness of about 2 mm.

Wide angle X-ray diffraction (WAXD) is based on the diffraction of a monochromatic X-ray beam by the crystallographic planes (hkl) of the polymer crystalline phase. Using a pole figure accessory, the intensity of the diffracted radiation for a given hkl plane is measured as the sample is rotated through all possible spherical angles with respect to the beam. This gives the probability distribution of the orientation of the normal to hkl plane with respect to the directions of the sample.

The Herman orientation function is given by [35]:

$$f = \frac{( 3 {cos}^{2} φ - 1 )}{2} \qquad ( 9 )$$

where φ is the angle between the unit cell axes (a, b, and c) and reference axes. Details about the calculations can be found elsewhere [35].

The orientation factors from WAXD are mainly due to the crystalline part, therefore no information about the orientation of the amorphous phase can be obtained. Small angle X-ray scattering (SAXS) was utilized to estimate the long period distance between the lamellae.

Thermal Analysis

Thermal properties of specimens were analyzed using a TA instrument differential scanning calorimeter (DSC) Q 1000. Samples were heated from 50 to 220° C. at a heating rate of 10° C./min.

BET Measurement

To obtain the surface area and pore diameter of the membranes, a flowsorb Quantachrome instrument BET ASI-MP-9 was used. A nitrogen and helium gas mixture was continuously fed through the sample cell, which was kept at liquid nitrogen temperature. At different pressures, the total volume of nitrogen gas adsorbed on the surface was measured. The volume of gas needed to create an adsorbed monomolecular layer was calculated as follows [41]:

$$\frac{P}{{P}^{°} [ v ( 1 - \frac{P}{{P}^{°}} ) ]} = \frac{1}{{v}_{m} c} + \frac{c - 1}{{v}_{m} c} \frac{P}{{P}^{°}} \qquad ( 10 )$$

where P is the experimental pressure, P° is the saturation pressure, v is the volume of the adsorbate, vₘ is the volume of gas required to form an absorbed monomolecular layer, and c is a constant. The procedure for estimating the surface area from Eq. 5 can be found elsewhere [42].

Mercury Porosimetry

The average pore size, pore size distribution, and porosity of the membranes were also evaluated using a mercury porosimeter (PoreMaster PM33). After evacuation of the cell, it is filled by mercury and then pressure is applied to force mercury into the porous sample. The amount of intruded mercury is related to the pore size and porosity.

Water Vapor Transmission

The permeability to water vapor was measured via a MOCON PERMATRAN-W Model 101 K at room temperature. It is composed of three chambers: an upper chamber containing the liquid water and separated from the center chamber by two porous films. Water vapor diffuses from the first film to fill the space between the films to reach 100% relative humidity (RH). The center chamber is separated from the lower one by the test film. The diffused vapor is swept away by N₂ gas to a RH sensor.

Mechanical Analysis

Tensile tests were performed using an Instron 5500R machine equipped with a chamber for running tests at high temperature. The procedure used was based on the D638-02a ASTM standard.

Puncture Resistance

Puncture tests were performed using a 10 N load cell of the Instron machine used for the tensile tests. A needle with 0.5 mm radius was used to pierce the samples. The film was held tight in the camping device with a central hole of 11.3 mm. The displacement of the film was recorded against the force (Newton) and the maximum force was reported as the puncture strength.

### Results and Discussion

### Rheological Characterization

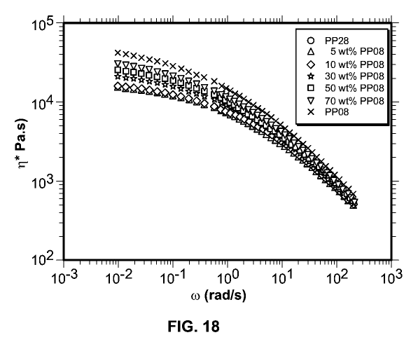

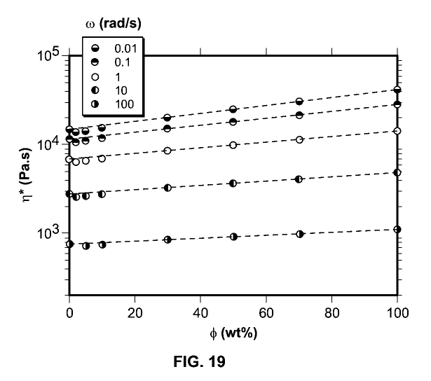

The complex shear viscosities as a function of frequency for the neat PPs as well as for the blends are shown in FIG. 18. The behavior is typical of linear polymer melts and the complex viscosity of the blends follows the log additivity rule as expected for miscible components. This is shown in FIG. 19 where the complex shear viscosities at different frequencies are plotted as a function of PP08 content. The logarithmic additivity rule is expressed as [43]:

log η*(ω)=φ_{β} log(η*(ω))₁+(1−φ_{β})log(η*(ω))₂ (11)

where φ_{β} is the PP08 content. Adding a high molecular weight component (PP08) causes monotonic increases of the complex shear viscosity, which is due to the presence of the larger molecules of PP08. Good agreement with the logarithmic mixing rule can be observed for all samples, suggesting miscibility of both PP components.

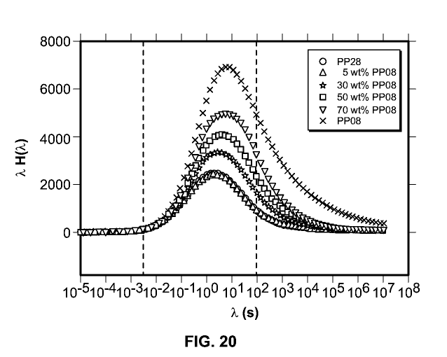

In order to quantitatively analyze the role of adding large chains on the melt relaxation of the blends, the weighted relaxation spectra evaluated from dynamic moduli (G′, G″, ω) using the NLREG (non-linear regularization) software [44] are plotted in FIG. 20 (the vertical dash lines represent the range of frequencies covered during the experiments). The addition of PP08 increases the number of entanglements, which retards the motion of the chains along their backbone, hence, the maximum in the curves is shifted to longer times and the spectrum shape becomes broader. Note that for the blends, the positions of the peaks are intermediate to those for the neat components suggesting again miscibility. The area under the curves is related to the zero shear viscosity and, as expected, increases with molecular weight.

The main mechanism of shear and/or elongation-induced crystallization is the propagation of the lamellae based on the fibrils or nuclei sites [35, 36]. As fibrils are mostly created from the long chains [32-34] and long chains have larger relaxation time (FIG. 20), therefore, adding a high molecular weight component favors the preparation of precursor films with an adequate level of crystalline lamellae.

The relaxation behavior can also be shown in Cole-Cole plots, which are plot of η″ versus η′ as illustrated in FIG. 21. The semicircular shape of the Cole-Cole for the blends is another evidence of miscibility [45, 46].

### Film and Membrane Characterization

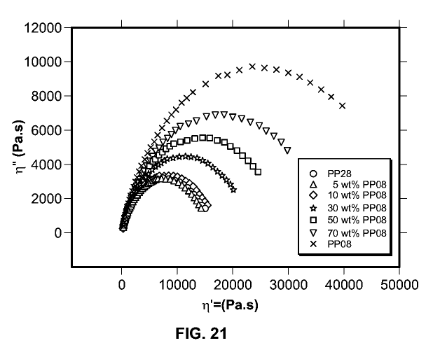

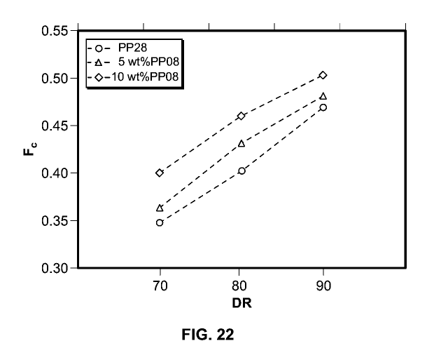

Draw ratios of 70, 80, and 90 were applied to the extruded films to investigate the role of the extension ratio on the orientation of the precursor films, as illustrated in FIG. 22. It is obvious that for all the blends, as the draw ratio increases, the orientation function for the crystalline phase obtained from FTIR increases. At the low draw ratios, the lamellae are not well aligned perpendicular to the flow direction, but as draw ratio increases the lamellae align themselves perpendicular to the machine direction. In addition, it should be noted that the blend precursor films exhibit larger crystalline orientation values than the neat PP precursor. These results are in agreement with the findings of Sadeghi et al. [35] for polypropylene (PP) and Johnson and Wilkes [47] for polyoxymethylene (POM), which showed that the orientation of the crystalline phase of precursor films increases as the molecular weight of the resins increases.

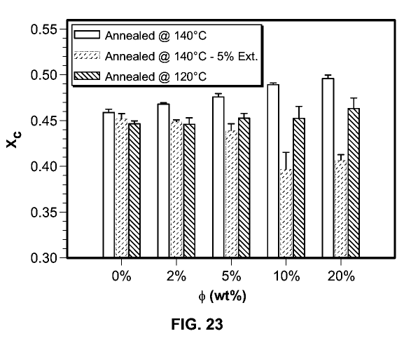

To determine the optimum annealing conditions that will lead to the largest amount of crystallinity, annealing at 140° C. without extension, at 140° C. under 5% extension, and at 120° C. without extension was carried out and the measured crystallinity values are plotted in FIG. 23. It is found that annealing at 140° C. in the absence of strain results into the largest crystallinity content. Large reduction in crystallinity was seen when the samples were annealed under 5% extension with respect to the initial length. This reduction was more pronounced for the blends with a high level of PP08 (i.e. 10 wt % PP08 and 20 wt % PP08). Johnson and Wilkes [48] examined the lamellar structure of polyoxymethylene (POM) annealed films under different levels of extension. Their experiments showed lamellar deformation for POM films annealed under tension levels larger than 3%. As a consequence, their POM microporous membranes annealed under no tension resulted in highly microporous films upon stretching. As will be shown later, 10 wt % PP08 blend contains more and smaller lamellae than the neat resin and blends of 2 and 5 wt % PP08. Therefore, more lamellae deformation for this blend during annealing under extension is expected, which explains the significant variation of crystallinity compared to the sample annealed without extension. Due to the larger number of nucleating sites for the samples having long chains, the enhancement of the crystallinity is apparent as the amount of PP08 increases.

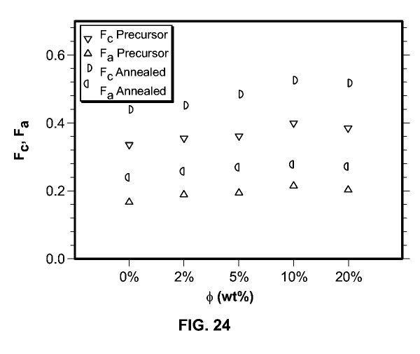

FIG. 24 presents the Herman orientation function of the crystalline phase as well as of the amorphous phase for the precursor and annealed films for all the blends. It is obvious that adding up to 10 wt % PP08 enhances the orientation of the both crystalline and amorphous phases. In addition, in comparison with the non-annealed films, significant improvement of the orientation is observed for the annealed specimens in the entire range of compositions. As annealing is performed at a temperature that is close to the onset of mobility in the crystalline structure (T_{α}), it is postulated that during annealing, the lamellae twist and orient perpendicular to the machine direction. Also, melting of small lamellae and their recrystallization with better orientation can occur [36]. The improvement of the orientation of the amorphous phase may be due to a slight movement of the molecules in the amorphous phase and formation of some organized regions. It has been reported that a slight tension during annealing enhances orientation [49], but in our case no dramatic improvement was observed.

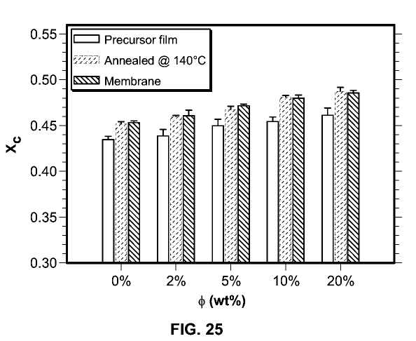

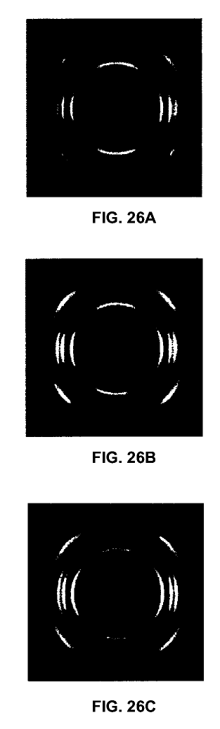

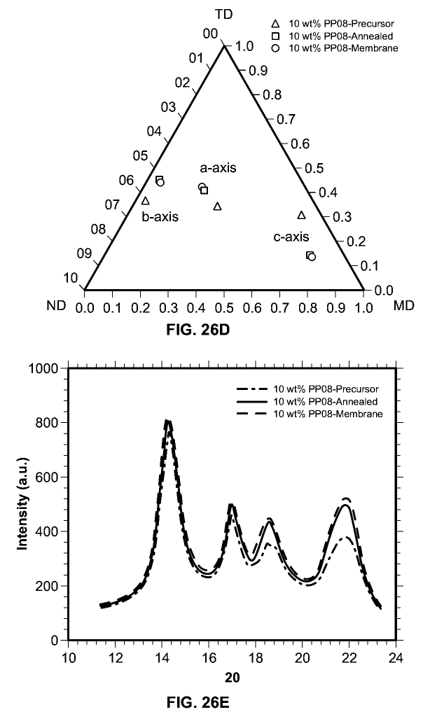

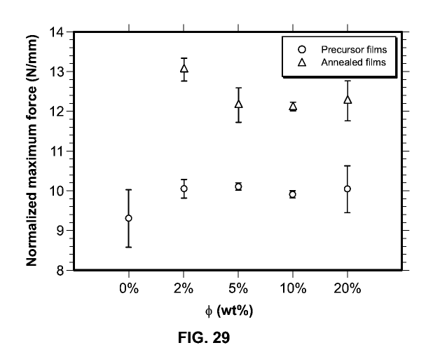

The effects of annealing and stretching on crystallinity were examined using differential scanning calorimetry (DSC) and the results are shown in FIG. 25. Due to chain rearrangements at temperatures close to the melting point of the samples, annealing improves the crystalline content for all the blends. A slight change in crystallinity was detected after stretching. In the melting curves (not presented here), a small peak close to the annealing temperature was observed for the annealed samples, which is attributed to the bimodal lamellae thickness distribution. This was also observed by other authors [36,50]. The effect of annealing on crystallization and orientation of the crystalline phase was also considered using WAXD, as shown in FIGS. 26a-c. The arcs are sharper and more concentrated in the center for annealed samples, suggesting more orientation. The orientation features as cos² (φ) of the crystalline axes (i.e. a, b, and c (see FIG. 29)) along MD, TD, and ND obtained from the Herman orientation function for the precursor, annealed, and stretched films are plotted in the triangular graph of FIG. 26d. It is obvious that annealing causes movement of the c-axis of the crystals towards MD, while the a- and b-axes take a position closer to the TD-ND plane. This obviously shows that annealing improves the orientation of the films, in accordance with the FTIR data. Clearly stretching does not dramatically influence the orientation of the unit cell. During the stretching step, only lamellae separation is expected to occur and no changes in the crystalline blocks take place. The 2θ diffraction intensity graph of the samples is shown in FIG. 26e. After deconvolution of the peaks and from the area under the curves, the crystallinity of the samples was calculated and similarly to the DSC results it was found that annealing improves crystallinity dramatically. However, the crystallinity obtained from WAXD was slightly larger than that obtained using DSC.

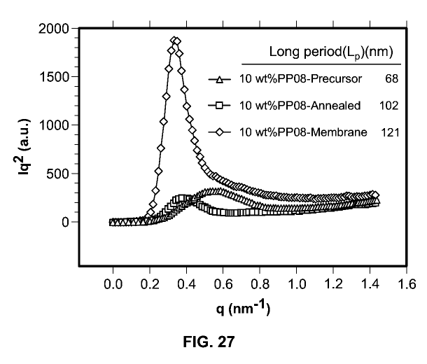

SAXS measurements were performed to examine the role of annealing and stretching on the lamellae spacing. The long period distance, Lₚ, was estimated from the position of the intensity maxima, as demonstrated in FIG. 27 (Lₚ=2/qₘₐₓ where q is the intensity vector, q=4π sin θ/λ). Annealing shifts the peaks to lower values, indicating an increase of the long spacing. Long spacing results of the precursor, annealed, and stretched films for the blend containing 10 wt % PP08 are also reported in FIG. 27. The value of 4 for the annealed film is much larger than that for the precursor film (Lₚ=68 nm compared to 102 nm). As no extension was applied during annealing, this increase is attributed to the increase of lamellae thickness. In contrast to WAXD results, a significant effect of stretching on SAXS intensity profile is observed. As mentioned above, SAXS can detect the distance between the lamellae, and during stretching the lamellae are separated and pores are created, so dramatic influence of stretching is observed in the SAXS patterns.

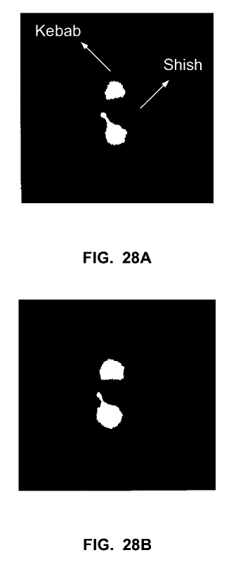

FIG. 28 shows the 2D SAXS patterns for the PP28 and 10 wt % PP08 blend films. The equatorial streak in the SAXS patterns is attributed to the formation of the shish, while meridian maxima are attributed to the lamellae or kebabs [3]. Looking at the meridian intensity, the formation of more lamellae for the blend containing 10 wt % PP08 is evident.

It has been shown that annealing significantly influences the tensile response of films [35]. According to Sadeghi et al. [35], due to the planar morphology of the annealed sample, the rupture along the MD for the annealed film occurs at much smaller strain than for the non-annealed film. Puncture tests were performed to investigate the effects of annealing on the mechanical properties of the samples along the ND, and the results are presented in FIG. 29. Each point is an average of over 10 tests. No significant changes were detected when PP08 was added. However, due to the thicker lamellae for the annealed samples, a pronounced increase of the maximum piercing force was observed for the annealed films compared to the precursor ones.

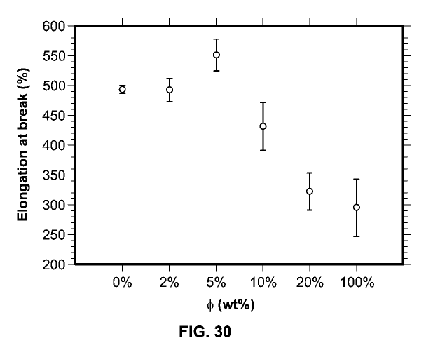

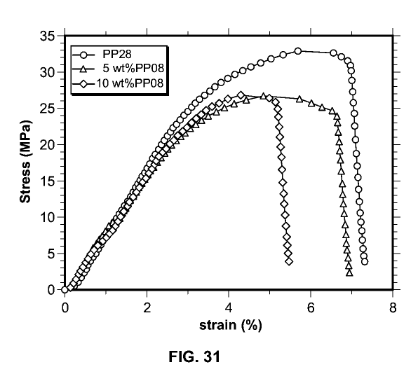

The effect of blending on the mechanical properties of precursor films along MD and TD is illustrated in FIGS. 30 and 31, respectively. FIG. 30 shows that blending reduces the elongation at break for the precursor films along the MD, except for the 5 wt % PP08 sample that shows a peak. The reason for the peak in the elongation at break for the 5 wt % PP08 is unclear at present. The following decrease in the elongation at break for the precursor films containing more PP08 is possibly due to the more orientation of the amorphous and crystalline phases for these samples (see FIG. 24). The tie chains between lamellae are more oriented and more fibrils are expected as the level of PP08 increases. It is well known that better orientation along MD results in less deformation at break. For the transverse direction, a reduction of the maximum stress and amount of elongation at break are also observed (FIG. 31). This can be explained by the larger number of fibrils and smaller lamellae for the blend films.

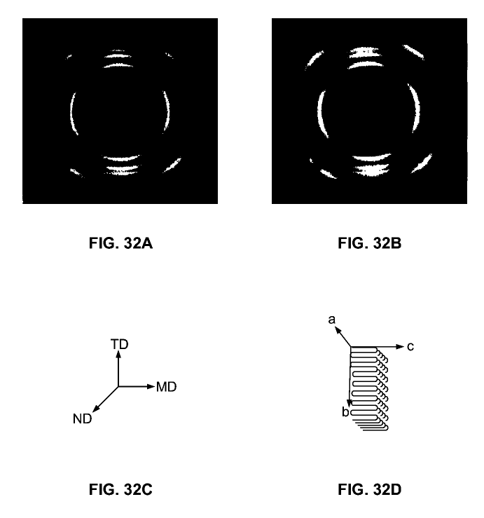

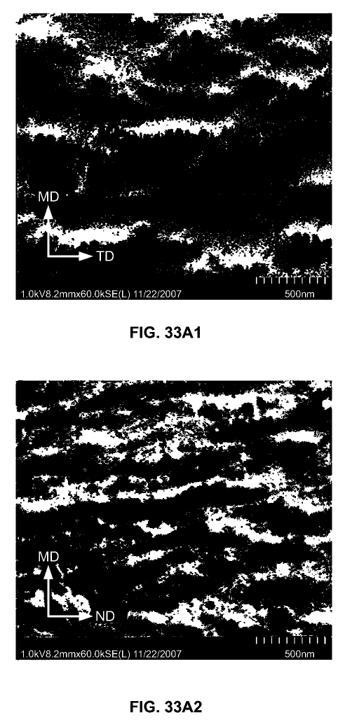

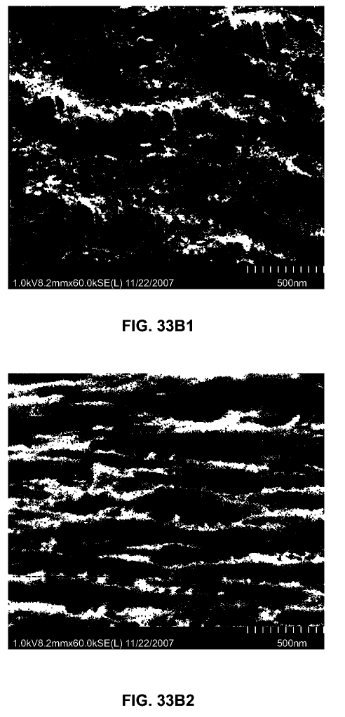

To control the final structure of the produced membranes, obtaining a precursor film with the adequate orientation and alignment of the crystal lamellae is needed. The WAXD measurements were performed to consider the influence of blending on the level of orientation, as illustrated in FIG. 32. The first and second rings of the pole figures show the patterns for the 110 and 040 crystalline planes, respectively [51]. The normal to the 110 plane is the bisector of the a and b axes and 040 is along the b-axis of the unit crystal cells [38]. More intense arcs in the meridian and equatorial zones are apparent for the blend sample, indicating greater orientation for the crystal lamellae [51].

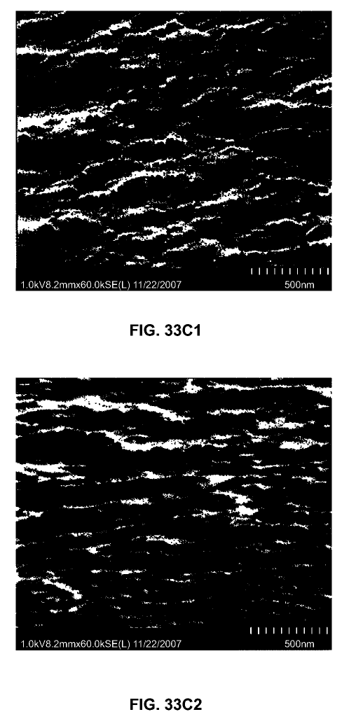

FIG. 33 presents SEM micrographs of the surface and cross-section of the fabricated membranes for PP28 and blends containing 5 wt % PP08 and 10 wt % PP08. FIG. 33a1 exhibits very thick lamellae and a small amount of pores for PP28 (i.e. low molecular weight component). However, as PP08 (i.e. high molecular weight component) is added, the number of pores increases and more uniform pore size and a better morphology is observed as well (FIGS. 33b1 and 33c1). This behavior can be explained as follows. As the content of the high molecular weight component increases, the number of fibrils or nuclei sites increases resulting in smaller lamellae and more pores. In addition, as was shown in FIG. 20, the long chains have longer relaxation time; this increases the probability for the formation of lamellae by the low molecular weight chains on the extended fibrils. It should be noted that the surface SEM micrographs of the porous membranes reveal greater lamellae orientation for the blend samples, confirming the WAXD results. Yu [49] investigated the lamellar structure of PE films blown with low and high molecular weight resins. Both polyethylenes exhibited a planar lamellar morphology, but the high M_{w} PE showed extended-chain nuclei, while the low M_{w} film possessed no evident extended-chain nuclei. As a result, the lateral lamellae dimensions were greater for the low M_{w} PE. Their findings are in line with our results shown in FIG. 33.

The neat PP28 membrane contains thicker lamellae in the precursor films and has lower orientation yielding in a difficult lamellae separation and less interconnectivity (FIG. 33a2). More pores and thinner lamellae for the wt % PP08 blend membrane lead to a better interconnectivity of the pores (FIG. 33c2). In addition, the membrane tortuosity, which is defined as the length of the average pore to the membrane thickness [52], seems to be less for the 10 wt % PP08 blend membrane than for the PP28 membrane. When SEM micrographs of the surface of the cold and hot stretched films were compared (SEM micrographs of the cold stretched films are not shown), the number of pores was found to be larger for the hot stretched samples. This confirms the findings of Sadeghi et al. [36] and it was explained by the melting of some lamellae and their recrystallization in the form of interconnected bridges during the hot stretching step.

Properties for membranes made from blends and their neat component are reported in Table 4. The membranes containing 5 wt % PP08 and 10 wt % PP08 exhibit pore densities about twice and four times that of the PP28 membrane, respectively. The PP08 microporous membrane shows pore density much lower than the 10 wt % PP08 membrane. The table also compares the results on specific surface area and average pore size of the membranes determined by BET and mercury porosimetry. The pore diameters obtained from BET and mercury porosimetry are almost identical. The specific surface area varies from 5.9 to 26.2 m²/g depending on the PP08 content. As the 10 wt % PP08 blend microporous membranes has smaller diameter pores the larger value for the specific surface area is due to its larger pore density. An average pore diameter of 0.12 μm was determined for the PP28, 5 wt % PP28 and 10 wt % PP28 membranes. It should be noted that the neat PP08 microporous membrane shows a much lower surface area but larger pores compared to the 10 wt % PP08 microporous membrane and the reason for these is discussed in the following paragraph.

TABLE 4
Properties of microporous membranes (28 μm thick). Annealing was performed at 140° C.
for 30 min; DR = 70, cold stretching of 35% followed by hot stretching of 55% (values are
averaged over 5 tests for each sample).

| | | Specific | | | Water vapor | |
|---|---|---|---|---|---|---|
| | Pore density | surface area | Pore diameter | | transmission rate | |
| | (number of | (m²/g) | (μm) | | (WVTR) | Young |
| | pores/square | BET | BET | Mercury | (g/m² · day) | modulus |
| | micron) | technique | technique | porosimetry | (±10% error) | (GPa) |
| PP28 | 19 | 5.9 | 0.13 | 0.11 | 3200 | 0.92 |
| 5 wt % PP08 | 37 | 13.9 | 0.12 | 0.11 | 5300 | 1.01 |
| 10 wt % PP08 | 77 | 26.2 | 0.11 | 0.12 | 9800 | 1.05 |
| PP08 | 45 | 14.3 | 0.21 | 0.23 | 16700 | 1.10 |

Table 4 also presents the water vapor transmission rates for the obtained microporous membranes. The permeability increased by a factor of 3 when 10 wt % PP08 was added to PP28. The addition of a high molecular weight component enhances the permeability, which is attributed to more pores, higher porosity, and better interconnection between the pores for the blend samples containing up to 10 wt % PP08. No significant increase of permeability was observed by further addition of PP08 except for the neat PP08 microporous membrane. In the blends, adding of more than 10 wt % PP08 possibly destroys the lamellar morphology, resulting in no changes or even lower permeability. Microporous membranes made of the neat PP08 showed a fibrillar structure with smaller number of lamellae (not presented here) than the 10 wt % PP08 microporous blend. This was due to the presence of larger number of long chains in PP08. Although the pore density of the PP08 porous membrane is much smaller than for the 10 wt % PP08 membrane, its pores are much larger leading to a better pore interconnection and larger WVTR. Although the permeability of the neat. PP08 membrane was larger than that of all blend membranes, the objective of this work as mentioned earlier is to control the performances of microporous membranes using polymer blends.

Also as shown by Table 4, the Young modulus of the membranes slightly increases as the amount of the high M_{w} PP increases (Table 4). This can be explained by the better orientation, of the lamellae for the blend films compared to the neat PP28.

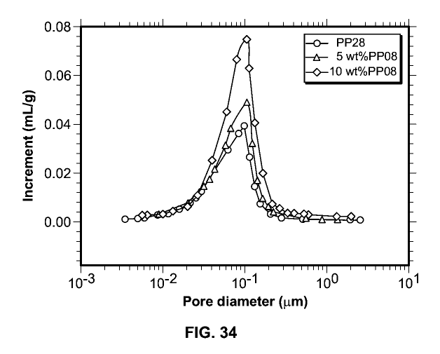

FIG. 34 reports the pore size distribution for the microporous neat PP and membranes containing 5 wt % and 10 wt % PP08. It is obvious that blending does not dramatically influence the peak positions in the pore size distribution curves and all the three samples reveal peaks around 0.11 μm. However, adding PP08 significantly enhances the area under curves, indicating porosity increases. Porosity values of 30, 35, and 44% were evaluated for the PP28, 5 wt % blend, and 10 wt % blend membranes, respectively. The lower porosity of the neat PP membrane is attributed to its thicker lamellae and, consequently, more resistant to lamellae separation. An improvement of porosity for a blend of 2 wt % long-chain branched polypropylene (LCB-PP) and a linear polypropylene (L-PP) was also reported by Sadeghi et al. [38]. This was explained by a better orientation of the crystal blocks for the blend sample.

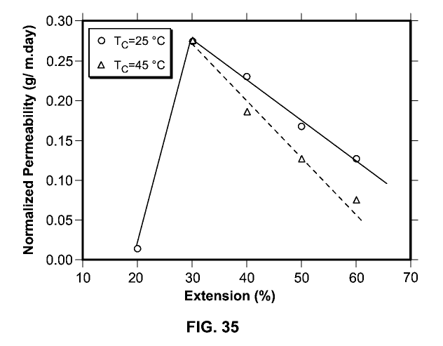

In the preparation of porous membranes using the stretching technique, voids are nucleated by cold stretching and enlarged by subsequent hot stretching [1,2]. According to Johnson [2], the micro void morphologies produced via this method are a consequence of inter lamellar separation, which takes place at temperatures above T_{g} of the specific semi crystalline polymer. This is in contrast to amorphous polymers which reportedly form voids (i.e. crazes, this process is termed crazing) upon deformation at temperatures below their respective T_{g}. Sadeghi et al. [8] found that the pores size of the cold stretched films obtained from the PP resins with distinct M_{w} did not significantly vary. However, a difference in the lamellae thickness was observed. To find the optimum cold stretching conditions, cold drawing was carried out at 25° C. and 45° C. and under predetermined amounts of extension while the amount of hot stretching was kept constant. FIG. 35 reports the water vapor transmission rate (WVTR) normalized (multiplied) by the membrane thickness as a function of the applied extension for 10 wt % PP08 porous membranes. It is obvious that 20% extension during cold stretching was not enough to initiate pores formation. However, a maximum was observed when 30% extension was applied while further stretching reduced the normalized WVTR. It is believed that the high level of extension during cold stretching causes the fibrils to get closer to each other, resulting in the collapse of the pores. Chu and Kimura [25] investigated the effects of stretching on porosity and permeability of microporous polypropylene films prepared by biaxial stretching. In accordance with our results, their findings showed that porosity and permeability of the drawn films increased as the stretching ratio increased up to an optimum value while further stretching resulted in their reduction. This was explained by pores collapse and closely packed structure due to fibril propagation at large draw ratios. In our case, it was also found that cold stretching at 25° C. yields larger permeability values.

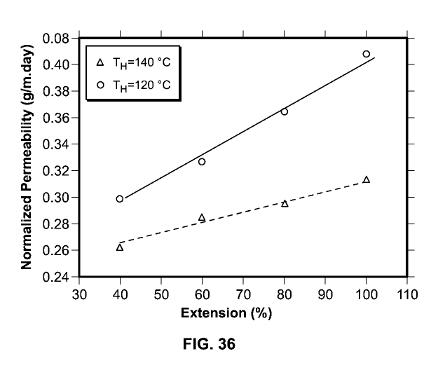

Similar experiments were performed to investigate the influence of hot stretching. In contrast to cold stretching, no maximum was observed when the films were stretched to different levels (FIG. 36). As mentioned, the pores created in cold stretching are enlarged during the hot stretching step. More flexibility of lamellae at high temperatures can be a reason for the increase of pore size with increasing draw ratio. However, hot stretching at 120° C. yields much larger WVTR values in comparison to stretching at 140° C.

In this work, the structure and performances of microporous membranes made from blends of linear low and high molecular weight PPs have been investigated. In addition, the influence of annealing conditions on the crystallinity and stretching variables on the water vapor transmission rate (WVTR) were examined. Our findings can be summarized as follows:
Good agreement with the logarithmic mixing rule of the complex viscosity was observed for all the blends suggesting miscibility of the both PP components.
Annealing at 140° C. without extension contributed significantly to the crystalline phase perfection. In addition, compared to films annealed without extension, annealing under small amount of extension resulted in a significant reduction of crystallinity.
SEM micrographs of the surface of membranes showed more uniform pores and a better distribution as the amount of the high molecular weight species increased.
More interconnectivity of the pores was observed when the level of high M_{w PP increased. This was explained by a larger number of pores and thinner lamellae for the blend membranes.}
By increasing the applied extension during hot stretching, water vapor transmission rate rose while for cold stretching the effect was inversed.

Using the puncture test, it was shown that addition of high molecular weight species does not have dramatic influence on the mechanical properties of precursor films along ND. However, tensile tests revealed a slight reduction of the mechanical properties along MD and TD.

3—Microporous Membranes Obtained from PP/HDPE Multilayer Films by Stretching

Commercially available lithium battery separators are made from polyolefins such as polypropylene (PP) and polyethylene (PE). These materials are compatible with the cell chemistry and can be used for many cycles without significant degradation in properties [54]. Lithium (Li) batteries will generate heat if accidentally overcharged. Separator shutdown is a useful safety feature for restricting thermal reactions in Li-batteries [54,55]. Shutdown occurs close to the melting temperature of the polymer, leading to pores collapse and restricting passage of current through the cell. PP separators melt around 160° C. whereas PE separators have shutdown temperature between 120 and 130° C. If in a battery, the heat dissipation is slow, even after shutdown, the cell temperature may continue to increase before starting to cool [54]. Recently, manufacturers have started producing trilayer separators where a porous PE layer is sandwiched between two porous PP layers. In such a case, the PE layer has lower shutdown temperature while PP provides the mechanical stability at and above the shutdown temperature [54].

Three commercially available processes are used for making microporous membranes: solution casting (also known as extraction process), particle stretching, and dry-stretching [56]. In the extraction process, the polymeric raw material is mixed with a processing oil or plasticizer, this mixture is extruded and the plasticizer is removed through an extraction process [57]. In the particle stretch process, the polymeric material is mixed with particles, this mixture is extruded, and pores are formed during stretching at the interface of the polymer and solid particles [58]. Costly processes and difficulties in dealing with solvent and particle contaminations are main drawbacks of such methods. However, the dry-stretch process is based on the stretching of a polymer film containing a row-nucleated lamellar structure [59]. Three consecutive stages are carried out to obtain porous membranes by this technique: 1) creating a precursor film having a row-nucleated lamellar structure through shear and elongation-induced crystallization of the polymer having proper molecular weight and molecular weight distribution, 2) annealing the precursor film at temperatures near the melting point of the resin to remove imperfections in the crystalline phase and to increase lamellae thickness, and 3) stretching at low and high temperatures to create and enlarge pores, respectively [59,60].

In fact, in this process, the material variables as well as the applied processing conditions are parameters that control the structure and the final properties of the fabricated microporous membranes [59]. The material variables include molecular weight, molecular weight distribution, and chain structure of the polymer. These factors mainly influence the row-nucleated structure in the precursor films in the first step of the formation of microporous membranes. According to Sadeghi et al. [61,62], molecular weight was the main material parameter that controlled the orientation of the row-nucleated lamellar structure. The resins with high molecular weight developed larger orientation and thicker lamellae than those with low molecular weight. In our recent study [63], the addition of up to 10 wt % of a high molecular weight component to a low molecular weight resin enhanced the formation of the row-nucleated structure due to an increase in the nucleating sites. In Sadeghi et al. [64], a superior permeability was obtained by adding a small amount of a long-chain branched polypropylene (LCB-PP) to a linear polypropylene (L-PP). The effects of process conditions such as draw ratio (DR), air flow rate (AFR), and cast roll temperature on the structure of PP cast films and microporous membranes have been investigated by the Applicants [65]. A significant enhancement in orientation was observed by applying air cooling and increasing DR. An ordered stacked lamellar structure was seen for the films subjected to low air cooling whereas the films produced without air cooling showed a spherulitic structure.

There are two main industrial processes for the production of films: film blowing and cast film extrusion. It is well known that the thickness variation in blown films are considerably greater compared to cast films. For the preparation of porous membranes, obtaining a precursor film with good thickness uniformity is strongly recommended since any non uniformity causes irregularities in the stress distribution in the following stretching process. In addition, compared to film blowing, cast film process has more flexibility in the supply of air cooling from both sides, leading to a more uniform lamellar structure in both surfaces.

### Materials

A commercial linear polypropylene (PP) and a commercial high density polyethylene (HDPE) were selected. PP5341E1 was supplied by ExxonMobil and had a melt flow rate (MFR) value of 0.8 g/10 min (under ASTM D1238 conditions of 230° C. and 2.16 kg). HDPE 19A was provided by NOVA Chemicals and had an MFR value of 0.72 g/10 min (under ASTM D1238 conditions of 190° C. and 2.16 kg). The main characteristics of the resins are shown in Table 5. The molecular weight (M_{w}) and polydispersity index (PDI) of the HDPE was supplied by company and that of the PP was measured using a GPC (Viscotek model 350) with 1,2,4-Trichlorobenzene (TCB) as a solvent at a column temperature of 140° C. The melting point, Tₘ, and crystallization temperature, T_{c}, of the resins obtained from differential scanning calorimetry at a rate of 10° C./min are also reported in Table 5.

TABLE 5
Main characteristics of neat polymers.

| Resin | | | M_{w} | | Tₘ | T_{c} |
|---|---|---|---|---|---|---|
| code | Company | MFR | (kg/mol) | M_{w}/Mₙ | (° C.) | (° C.) |
| PP5341E1 | ExxonMobil | 0.8 | 361 | 2.7 | 162 | 112 |
| | | 230° C./ | | | | |
| | | 2.16 kg | | | | |
| HDPE | NOVA | 0.72 | 126 | 7.8 | 129 | 118 |
| 19A | Chemicals | 190° C./ | | | | |
| | | 2.16 kg | | | | |

### Rheological Characterization

Dynamic rheological measurements were carried out using a Rheometric Scientific SR5000 stress controlled rheometer with a parallel plate geometry of 25 mm diameter and a gap equal to 1.5 mm at the temperature of 190° C. under nitrogen atmosphere. Molded discs of 2 mm thick and 25 mm in diameter were prepared using a hydraulic press at 190° C. Prior to frequency sweep tests, time sweep tests at a frequency of 0.628 rad/s and 190° C. were performed for two hours to check the thermal stability of the specimens. No degradation (less than 3% changes) was observed for the duration of the frequency sweep measurements. Complex viscosity and weighted relaxation spectrum in the linear viscoelastic regime were determined in the frequency range from 0.01 to 500 rad/s. In order to obtain more accurate data, the frequency sweep test was carried out in four sequences while the amount of applied stress in each sequence was determined by a stress sweep test.

### Film and Membrane Preparation

The cast films were prepared using an industrial multilayer cast film unit from Davis Standard Company (Pawcatuck, Conn.) equipped with a 2.8 mm opening and 122 cm width slit die and two cooling drums. The extrusion was carried out at 220° C. and the distance between the die exit to the nip roll was 15 cm. The die temperature was set at 220° C. and draw ratios of 60, 75, and 90 were applied. An air knife with dimensions of 3 mm opening and 130 cm width was mounted close to the die to provide air to the film surface right at the exit of the die. The variables of interest were draw ratio and amount of air flow. The films were produced under chill roll temperature of 50° C. The air cooling rates used were 1.2 and 12 L/s. These air cooling conditions are noted as: low air flow rate (L-AFR) and high air flow rate (H-AFR), respectively.

For the membrane fabrication, the precursor films with thickness, width, and length of 32 μm, 46 mm, and 64 mm, respectively, were used. The films were first annealed at 120° C. for 30 min and then cold and hot stretched at 25° C. and 120° C., respectively. Both annealing and stretching were performed in an Instron tensile machine equipped with an environmental chamber. Drawing speeds of 500 mm/min and 25 mm/min were applied during cold and hot stretching steps, respectively.

### Film and Membrane Characterization

Thermal Analysis

Thermal properties of specimens were analyzed using a TA instrument differential scanning calorimeter (DSC) Q 1000. The thermal behavior of films was obtained by heating from 50 to 220° C. at a heating rate of 10° C./min. The reported crystallinity results were obtained Using a heat of fusion of 209 and 280 J/g for fully crystalline PP and HDPE, respectively [66,67].

Fourier Transform Infrared Spectroscopy (FTIR)

For FTIR measurements, a Nicolet Magna 860 FTIR instrument from Thermo Electron Corp. (DIGS detector, resolution 2 cm⁻¹, accumulation of 128 scans) was used. The beam was polarized by means of a Spectra-Tech zinc selenide wire grid polarizer from Thermo Electron Corp. The measurement is based on the absorption of infrared light at certain frequencies corresponding to the vibration modes of atomic groups present within the molecule. In addition, if a specific vibration is attributed to a specific phase, the orientation within that phase can be determined [61]. If the films are oriented, the absorption of plane-polarized radiation by a vibration in two orthogonal directions, specifically parallel and perpendicular to a reference axis (MD), should be different. The ratio of these two absorption values is defined as the dichroic ratio, D [61]:

$$D = \frac{{A}_{0}}{{A}_{⊥}} \qquad ( 12 )$$

where [symbol] is the absorption parallel and A_{⊥} is the absorption perpendicular to a specific reference axis. The Herman orientation function of this vibration is obtained according to [61]:

$$F = \frac{D - 1}{D + 2} \qquad ( 13 )$$

For polypropylene, absorption at the wavenumber of 998 cm⁻¹ is attributed to the crystalline phase (c-axis) while that at 972 cm⁻¹ is due to the contribution of both crystalline and amorphous phases. From the former absorption, the orientation of the crystalline phase, F_{c}, can be determined while from the latter, the average orientation function, F_{avg}, is obtained. The orientation of the amorphous phase, F₈, can then be calculated according to:

F_{avg}=X_{c}F_{c}+(1−X_{c})Fₐ (14)

where X_{c} is the degree of the crystallinity.

For polyethylene, absorption at the wavenumber of 730 cm⁻¹ is attributed to the a-axis of the unit crystal cell while absorption at the wavenumber of 720 cm⁻¹ is due to the b-axis. The similarity of the normal (N) and transverse (T) spectra confirmed that the orientation is mostly uniaxial [68]. In such a case, it is not necessary to use the tilted film technique. The orientation function of the a- and b-axes could be obtained from Eq. 13 while that of the c-axis orientation is calculated according to the orthogonality equation:

Fₐ+F_{b}+F_{c}=0 (15)

X-Ray Diffraction

XRD measurement was carried out using a Bruker AXS X-ray goniometer equipped with a Hi-STAR two-dimensional area detector. The generator was set up at 40 kV and 40 mA and the copper CuKα radiation (λ=1.542 A°) was selected using a graphite crystal monochromator. The sample to detector distance was fixed at 9.2 cm for wide angle diffraction and 28.2 cm for small angle X-ray scattering analysis. To get the maximum diffraction intensity several film layers were stacked together to obtain the total thickness of about 2 mm.

Wide angle X-ray diffraction (WAXD) is based on the diffraction of a monochromatic X-ray beam by the crystallographic planes (hkl) of the polymer crystalline phase. Using a pole figure accessory, the intensity of the diffracted radiation for a given hkl plane is measured as the sample is rotated through all possible spherical angles with respect to the beam. This gives the probability distribution of the orientation of the normal to hkl plane with respect to the directions of the sample.

The Herman orientation function Fᵢⱼ of a crystalline axis i with respect to a reference axis j is given by [69]:

$${F}_{ij} = \frac{( 3 {cos}^{2} {φ}_{ij} - 1 )}{2} \qquad ( 16 )$$

where φᵢⱼ is the angle between the unit cell axes i (a, b, or c) and the reference axis j.

The Herman orientation functions were derived from the 110 and 040 pole figures for the PP and the 110 and 200 pole figures for the HDPE. Details about the calculations for PP can be found in Sadeghi et al. [61]. For the HDPE, since the a-axis of the unit cells is perpendicular to the 200 plane, its orientation relative to the machine direction can be measured directly as follow:

$${F}_{a} = {F}_{200} = \frac{3 {cos}^{2} {φ}_{200} - 1}{2} \qquad ( 17 )$$

On the other hand, F_{c} (orientation of the c-axis) with respect to MD is determined by the combination of data of two planes for the HDPE, which are 110 and 200 [69]:

cos²φ_{c}=1−1.435 cos²φ₁₁₀−0.565 cos²φ₂₀₀ (18)

The orientation parameter for the b-axis can be calculated from the orthogonality relation:

cos²φ_{b}=1−cos²φₐ−cos²φ_{c} (19)

The orientation factors from WAXD are mainly due to the crystalline part, therefore no information about the orientation of the amorphous phase can be obtained. Small angle X-ray scattering (SAXS) was used to compare the level of the lamellae formation for the different samples and to estimate the long period between lamellae.

Mechanical Analysis and Puncture Resistance

Tensile tests were performed using an Instron 5500R machine equipped with an environmental chamber for tests at high temperature. The procedure used was based on the D638-02a ASTM standard. Puncture tests were performed using a 10 N load cell of the Instron machine used for the tensile tests. A needle with 0.5 mm radius was used to pierce the samples. The film was held tight in the camping device with a central hole of 11.3 mm. The displacement of the film was recorded against the force and the maximum force was reported as the puncture strength. Strain rates of 50 mm/min and 25 mm/min were utilized during tensile and puncture tests, respectively.

Morphology

To clearly observe the crystal arrangement of the precursor films, an etching method was employed to remove the amorphous part. The films were dissolved in a 0.7% solution of potassium permanganate in a mixture of 35 vol % of orthophosphoric and 65 vol % of sulphuric acid. The potassium permanganate was slowly added to the sulphuric acid under rapid agitation. At the end of the reaction time, the samples were washed as described in Olley and Bassett [70].

A field emission scanning electron microscope (FE-SEM—Hitachi S4700) was employed for the observation of the etched precursor films and microporous membranes surfaces as well as cross-sections. This microscope provides high resolution of 2.5 nm at a low accelerating voltage of 1 kV and high resolution of 1.5 nm at 15 kV with magnification from 20× to 500 kx.

Water Vapor Transmission

The permeability to water vapor was measured via a MOCON PERMATRAN-W Model 101 K at room temperature. It is composed of three chambers: an upper chamber containing liquid water and separated from the center chamber by two porous films. Water vapor diffuses from the first film to fill the space between the films to reach 100% relative humidity (RH). The center chamber is separated from the lower one by the test film. The diffused vapor is swept away by N₂ gas to a relative humidity (RH) sensor.

BET Measurement

To obtain the surface area of the membranes, a Micromeritics, BET Tristar 3000 was used. A nitrogen and helium gas mixture was continuously fed through the sample cell, which was kept at liquid nitrogen temperature. At different pressures, the total volume of nitrogen gas adsorbed on the surface was measured. The volume of gas needed to create an adsorbed monomolecular layer was calculated as follows [71]:

$$\frac{P}{{P}^{°} [ V ( 1 - \frac{P}{{P}^{°}} ) ]} = \frac{1}{{V}_{m} c} + \frac{c - 1}{{V}_{m} c} \frac{P}{{P}^{°}} \qquad ( 20 )$$

where P is the experimental pressure, P° is the saturation pressure, V is the volume of the adsorbate, Vₘ is the volume of gas required to form an absorbed monomolecular layer, and c is a constant. The procedure for estimating the surface area from Eq. 20 can be found elsewhere [72].

Rheological and Film Characterization

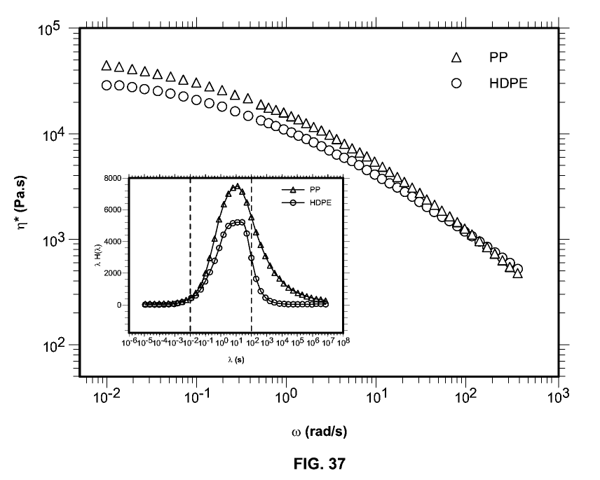

The complex shear viscosities as a function of frequency for the resins are shown in FIG. 37. The PP reveals larger viscosity compared to the HDPE in the Newtonian region (low frequencies) while the data cross over in the power-law region (high frequencies). It is well known that for the production of multilayer films the viscosity of the neat polymers should be close to each other in order to prevent instabilities and non uniformities at the interface. In our case, the viscosities of the PP and HDPE are nearly identical at the processing deformation rates (large frequencies). The inset in FIG. 37 compares the weighted relaxation spectra of the resins evaluated from dynamic moduli (G′, G″, ω) using the NLREG (non linear regularization) software [73] (the vertical dash lines represent the range of frequencies covered during the experiments). The area under the spectrum curve represents the zero-shear viscosity of the melt and as expected is larger for the PP compared to the HDPE. By considering the characteristic relaxation time, ω_{c}, corresponding to the peak of the curves, it can be seen that the HDPE exhibits slightly larger relaxation time than the PP.

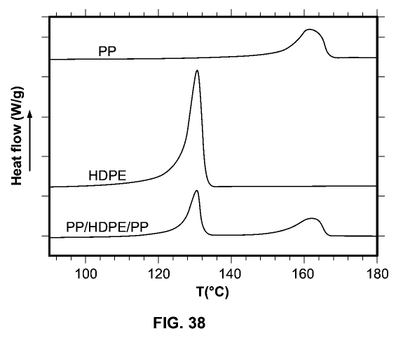

FIG. 38 presents the DSC heating thermograms for the PP and HDPE monolayer films as well as their multilayer film. The PP and HDPE exhibit melting peaks around 162° C. and 129° C., respectively, whereas the multilayer film shows two melting peaks at the same temperatures as the single layers. The PP monolayer film prepared under DR=90 and H-AFR showed a crystallinity of 44.2% and the HDPE monolayer film produced under the same conditions had a crystallinity of 74.0%. The crystallinities of the components in the multilayer film were slightly lower than that measured for the monolayer films:

To produce microporous membranes by the stretching technique, precursor films with an adequate orientation and alignment of the crystal lamellae are needed [62,63]. The higher the crystalline alignment in the precursor, the better is expected the lamellae separation and, as a consequence, the larger the porosity and permeability of the microporous membranes. In this study, the roles of draw ratio (DR), cooling air flow rate (AFR), and annealing on the crystalline alignments of single layer films as well as the components in a multilayer film are probed using WAXD and FTIR.

From literature, in PE, two major types of crystallization can occur depending on the magnitude of stress in flow [74]: low stress produces kebabs in the form of twisted ribbons resulting in off-axis 110 and meridian 200 diffractions. In contrast, high stress produces flat kebabs (planar crystal structure) leading to the appearance of equatorial 110 and 200 diffractions. When the magnitude of flow is in-between, an intermediate arrangement is formed, resulting in off-axis 200 and 110 diffractions [74]. However, PP under flow usually generates planar lamellar morphology with less dependence on the flow magnitude [65].

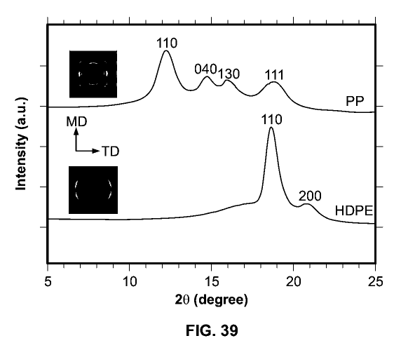

The WAXD patterns as well as the diffraction intensity profiles for the PP and HDPE shown in FIG. 39 reveal four and two diffractions, respectively, corresponding to the indicated crystallographic planes. As described earlier, for the PP, the 110 and 040 crystalline planes and for the HDPE, the 110 and 200 crystalline planes were used to obtain the orientation of the unit crystal cell axes (a, b, and c) with respect to MD, TD, and ND. However, due to overlapping of the 111 crystalline plane of PP and both 110 and 200 crystalline planes of HDPE, WAXD cannot be employed for the orientation measurement of the HDPE phase in the multilayer film. FTIR compensates this disadvantage of WAXD, since the infrared absorption peaks for PP and HDPE are quite distinct.

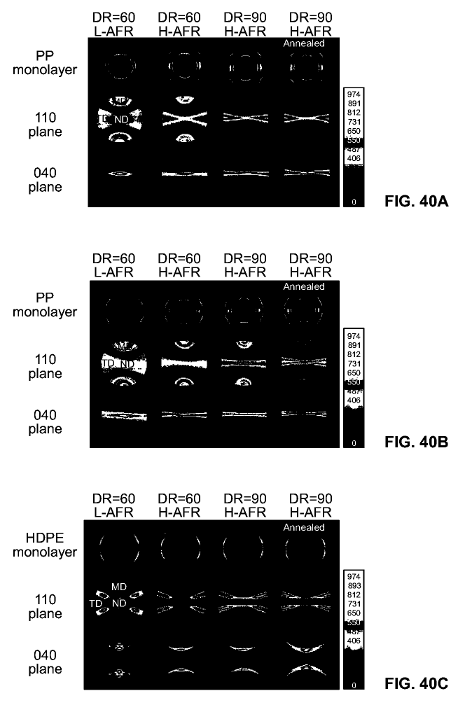

FIG. 40 demonstrates the effect of AFR, DR, and annealing on the diffraction patterns as well as on the pole figures of the PP and HDPE monolayer films and the PP in the trilayer film. The normal to the 110 plane is the bisector of the a and b axes and 040 and 200 are along the b-axis and a-axis of unit crystal cells, respectively [69]. From the WAXD patterns of the PP monolayer (FIG. 40a), it is clear that by increasing DR and AFR or annealing, the arcs become sharper and more concentrated in the center, implying more orientation. The pole figures of the PP single layer obtained at DR=60 and L-AFR reveal slight orientations of the 110 and 040 planes in MD and ND, respectively. The PP precursor produced under DR=60 and H-AFR shows significant orientation of the 110 plane along TD. In addition, increasing DR (i.e. DR=90) improves the orientation of the 110 plane along TD and that of the 040 plane (b-axis) is aligned in both TD and ND. Furthermore, annealing causes the 110 plane to be more aligned in TD. Similar trends for the influences of DR, AFR, and annealing on the crystalline alignment of the PP component in the trilayer film are observed (FIG. 40b). However, the 110 plane of the PP in the multilayer made at DR=60 and H-AFR has not moved into TD, indicating less orientation than the PP monolayer produced under the same conditions. A less alignment of the PP in the multilayer compared to that in single layer is also observed for the films produced under high DR (i.e. DR=90) and for the annealed ones and this will be discussed later. The four off-axes arcs for the 110 plane of the HDPE are observed in FIG. 40c that is a typical behavior of the twisted lamellar structure of PE where the a-axis rotates around the b-axis, resulting in the rotation of the reciprocal vector of the 110 plane. The pole figures of the HDPE single layer obtained at DR=60 and L-AFR shows a significant orientation of the 200 plane (a-axis) along MD and that of the 110 plane along both TD and ND. Increasing air cooling to the films surface (i.e. H-AFR) improves orientation of the 110 plane along TD and reduces the alignment of the 200 plane along MD drastically. Additionally, increasing DR and annealing slightly enhance the orientation of the crystallographic planes of the HDPE monolayer. As mentioned previously, to determine the orientation of the HDPE phase in the multilayer film, an FTIR technique was used and the results are discussed in the following paragraph. However, before presenting the results, it should be mentioned that the orientation functions for the HDPE single layer obtained using FTIR were slightly larger than the ones from WAXD pole figures. These discrepancies in the values of measured c-axis orientation may be due to different factors such as peak deconvolution, contributions of the amorphous phase, etc. as discussed for PE and PP elsewhere [75,76].

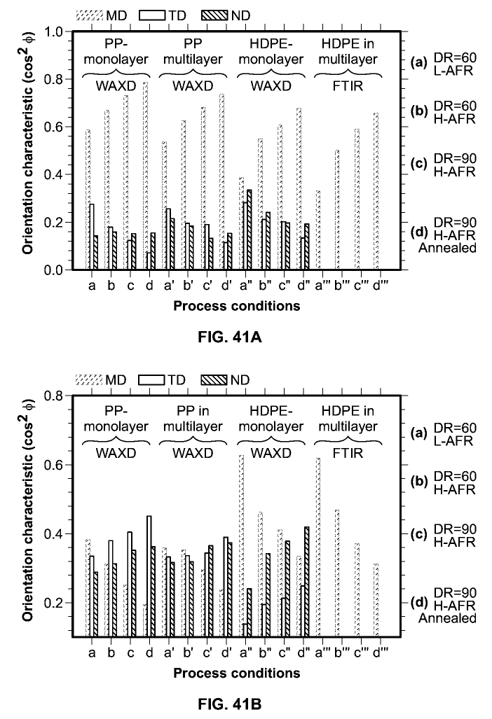

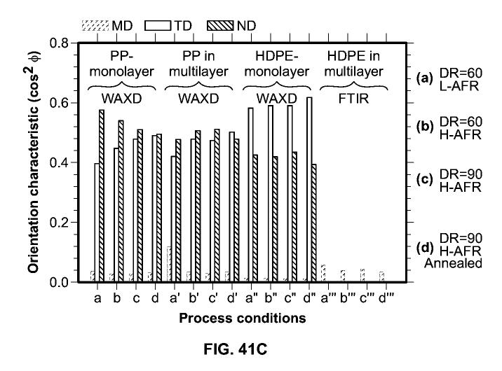

The orientation features, in terms of cos² (φ) of the crystalline axes (i.e. a, b, and c) along MD, TD, and ND obtained from the Herman orientation function for the PP and HDPE single layers as well as the components in the multilayer film are presented in FIG. 41. As expected, the c-axis orientation characteristics along MD (FIG. 41a) improve by increasing AFR and DR or by annealing. In addition, obviously, the c-axis alignment of the HDPE (both in the monolayer and multilayer) is significantly lower than that of the PP and also the c-axis orientation along MD of the PP and HDPE in the multilayer is lower than in the monolayer made under the same conditions, in accordance with the results discussed in FIG. 40. As reported above, the HDPE has much higher crystallinity and larger heat of fusion compared to the PP, resulting in a large heat release during its crystallization. This can explain lower orientation of the PP component in the trilayer than the PP monolayer. Looking at the orientation characteristics of the a-axis (FIG. 41b), significant orientation of this axis along MD is seen for the HDPE whereas the PP shows much lower values, confirming the presence of a different row-nucleated lamellar crystal morphology in the HDPE compared to the PP. As pointed out earlier, the large alignment of the a-axis along MD is a typical behavior of the twisted lamellar morphology. However, it should be noted that orientation of the a-axis along MD decreases drastically by increasing AFR and DR. This implies the presence of an intermediate structure between twisted and flat kebabs for HDPE, which was supported by the appearance of off-axis equatorial 110 and 200 diffractions in their WAXD patterns as well as pole figures (see FIG. 40c). The orientation characteristics of the b-axis along MD are very small for both the PP and HDPE (FIG. 41c) and do not change drastically with the process conditions.

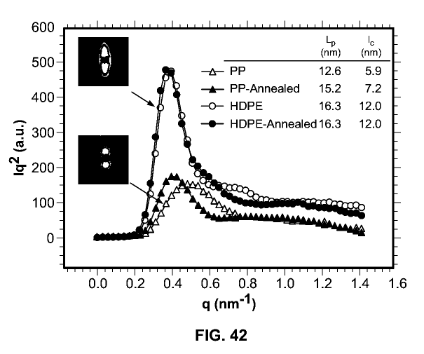

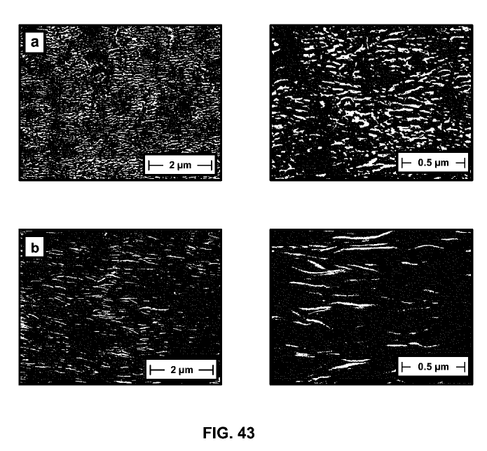

FIG. 42 illustrates the SAXS patterns as well as the Lorentz corrected intensity profile for the precursor and annealed single layer films of the PP and HDPE obtained at DR=90 and H-AFR. The equatorial streak in the SAXS patterns is attributed to the formation of the shish, while the meridian maxima are attributed to the lateral lamellae or kebabs [77]. Looking at the meridian intensity, the formation of more lamellae for the HDPE is obvious. In addition, it is clear that the contribution of the shish to the crystalline phase is much less than that of lamellae, confirming the results of Somani et al. [78] for PE and PP. The long period distance, Lₚ, was estimated from the position of the Lorentz corrected intensity maxima, as demonstrated in FIG. 42 (Lₚ=2π/qₘₐₓ where q is the intensity vector, q=4π sin θ/λ). Annealing shifts the peak of the PP precursor to lower values, indicating an increase of the long period spacing. However, annealing does not impact the peak position of the HDPE, implying that Lₚ remains mainly unchanged. The lamellae thickness, l_{c}, could be calculated by multiplying Lₚ by the crystalline fraction (see the legend in figure). The values of Lₚ and l_{c} for the PP precursor film are much smaller than those for the HDPE and increase with annealing.

Differences in the crystal structure and arrangement of the precursor films can be clearly visualized from SEM surface images of the etched films (etching removes the amorphous region), as demonstrated in FIG. 42. A uniform and ordered stacked lamellar structure and a uniform twisted lamellar morphology are seen for the PP and HDPE films, respectively (higher magnification images are shown on the right), confirming the XRD results of FIGS. 40 and 41.

It is well established that the structure of the crystalline phase strongly influences the mechanical properties of films. Zhang et al. [79] studied the microstructure of LLDPE, LDPE, and HDPE blown films and showed that the type of oriented structure was greatly dependent on the type of polyethylene as well as on the processing conditions. In our previous study [65], significant increases in the Young modulus, yield stress, tensile strength, tensile toughness along MD and a drastic decrease in the elongation at break along TD were observed for polypropylene cast films subjected to air cooling. Table 6 reports the results on the mechanical properties of the films along MD and TD for DR=60 and 90. All the properties improve along. MD and elongation at break along TD reduces with increasing DR, due to better crystal alignment. Additionally, it should be noticed that the mechanical properties of the trilayer films are between those of the monolayer films.

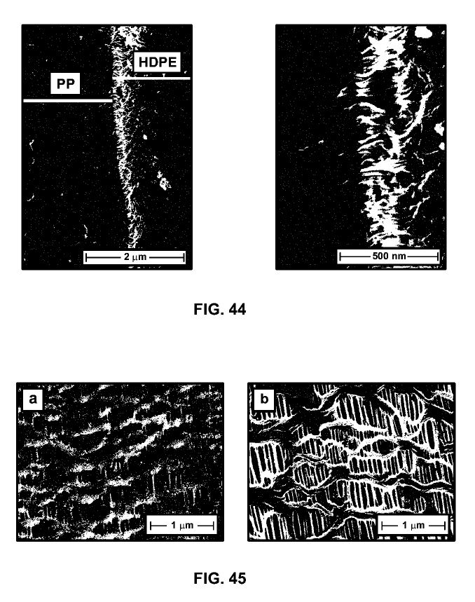

In general, blends of PP and HDPE are known to be immiscible systems. The interfacial morphology for the etched multilayer film is illustrated in FIG. 44. Some transcrystallization zone around the interface can be easily distinguished; they are the PE lamellae nucleated on the PP. In other words, crystallization of the PE overgrows at the interface. A transcrystalline layer is formed when a large number of nuclei are formed on an interface such that the crystallites are forced to grow normal to the interface and when a larger difference in crystallization temperature is present [79], which is the case between HDPE and PP (see Table 5). It should also be noted that at the interface, the HDPE lamellae penetrate into the PP phase. Some transcrystallization at the interface of a PP and a LLDPE was moreover observed by Zhang and Ajji [76]. However, in that case, the LLDPE lamellae could not diffuse into the PP. This behavior was explained as due to the much lower crystallization temperature, T_{c}, of the LLDPE (i.e. 104° C.) than the PP (i.e. 112° C.) [79] that prevented the penetration of the LLDPE lamellae into the initially crystallized PP layer. However, in our case, T_{c} of the HDPE (i.e. 118° C.) was larger than that of the PP (i.e. 112° C.), hence the HDPE crystallites could diffuse inside the molten PP layer.

TABLE 6
Mechanical properties of the cast films along MD and TD (the numbers in
parentheses indicate the standard deviation of the measurements); H-AFR.

| | Mechanical properties | | | | Mechanical properties | |
|---|---|---|---|---|---|---|
| | along MD | | | | along TD | |
| | Young | Tensile | Tensile | Strain | Tensile | |
| | modulus | strength | toughness | at | strength | Strain |
| | (MPa) | (MPa) | (MPa) | break | (MPa) | at break |
| PP-DR = 60 | 898.0 (35.5) | 46.7 (5.2) | 106.7 (3.3) | 4.0 (0.1) | 16.2 (1.9) | 0.456 (0.191) |
| PP-DR = 90 | 956.5 (34.2) | 60.7 (3.3) | 154.0 (16.8) | 3.7 (0.3) | 16.6 (1.4) | 0.065 (0.005) |
| HDPE-DR = 60 | 973.7 (90.0) | 51.0 (1.5) | 88.6 (4.2) | 2.9 (0.1) | 16.5 (1.6) | 0.014 (0.003) |
| HDPE-DR = 90 | 1138.8 (69.8) | 51.7 (2.3) | 96.0 (5.1) | 3.2 (0.2) | 21.6 (0.4) | 0.021 (0.002) |
| PP/HDPE/PP-DR = 60 | 920.0 (85.2) | 55.0 (5.1) | 140.4 (20.0) | 5.2 (0.4) | 15.6 (1.2) | 0.024 (0.003) |
| PP/HDPE/PP-DR = 90 | 1037.3 (126.0) | 60.4 (3.4) | 164.5 (18.9) | 4.0 (0.5) | 18.7 (3.0) | 0.036 (0.004) |

The produced precursor films should be annealed at a proper temperature before to be cold and hot stretched. As annealing is performed at a temperature that is above the onset of mobility in the crystalline structure (T_{α}), it is postulated that during annealing, the lamellae twist and orient perpendicular to the machine direction. Also, melting of small lamellae and their recrystallization with better orientation can occur [63]. Our previous study [63] showed that annealing at 140° C. without extension was the optimum annealing condition for PP. However, because Tₘ of the HDPE is around 129° C., the annealing temperature of the trilayer film should be lower than the HDPE melting point and above the alpha transition temperature, T_{α}, of the PP (T_{α,PP}=110° C. obtained from the dynamic mechanical thermal analysis). Therefore, we selected 120° C. for annealing of the trilayer film. In order to be able to compare the results, the single layer precursor films were annealed at the same temperature.

### Membrane Characterization

FIG. 45 presents SEM micrographs of the surface of the monolayer microporous membranes' prepared at the cold and hot stretching extensions of 55% and 75%, respectively. The details about the optimum cold and hot stretching levels will be discussed later. The distribution of interlamellar tie chains in the precursor films may not be uniform [80]. Therefore, it is believed that the micropores are first developed in region with a small amount of tie chains. It is clear that the size of the pores in the HDPE microporous membrane is much greater than in the PP membrane. The longer interlamellar microfibrils (bridges) in the HDPE porous membrane compared to the PP porous membrane are believed to be due to the longer tie chains in the precursor film of the former. It should be mentioned that the surface morphology of the PP/HDPE/PP membrane (not shown) was somewhat similar to the surface structure of the PP monolayer exhibited in FIG. 45.

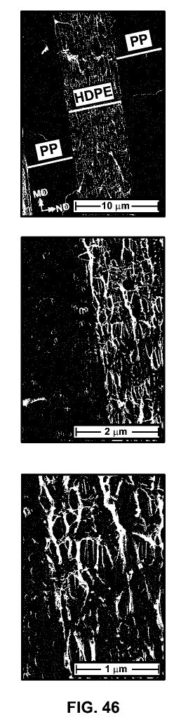

FIG. 46 illustrates SEM micrographs of the cross-section of the multilayer porous membrane. In FIG. 46a, it is obvious that a porous HDPE layer has been sandwiched between two porous PP layers while the three layers have almost identical thicknesses. FIGS. 46b and 46c present the interface between the layers at different magnifications. Similar to the surface micrographs, it is clearly recognized that the HDPE layer has much larger pores than the PP layer. Additionally, a reasonable adhesion between the layers is seen, which can be explained by the transcrystallization and penetration of the HDPE lamellae into the PP layer observed in the cross-section image of the trilayer precursor film shown in FIG. 44.

Table 7 presents the mechanical properties along MD and TD as well as the puncture resistance along ND for the microporous membranes. Obviously, the porous membranes have nearby similar tensile responses in MD and, as expected, the tensile properties along TD are considerably smaller than in MD. However, the PP microporous membranes show a much lower strain at break along TD than that the HDPE and multilayer membranes. In addition, due to the presence of the elongated interlamellar microfibrils in the microporous membranes, a pronounced increase in the tensile strength and a drastic decrease in elongation at break are observed for the membranes compared to the precursor films (see Tables 6 and 7). The decrease in the modulus for the membranes compared to the precursor films is possibly due to the lower interconnection between the lamellae in the membranes as a result of the tie chains pulled out during the pores formation. Also as shown by Table 7, the maximum piercing force is considerably larger for the PP membrane than the HDPE membrane, which can be explained by the smaller pores and lower porosity for the former. Therefore, it could be concluded that in the PP/HDPE/PP membranes, the side layers (i.e. PP) improve the puncture resistance drastically.

### Effect of Cold and Hot Stretching

TABLE 7
Mechanical properties of microporous membranes (20 μm thick). Annealing was
performed at 120° C. for 30 min; DR = 70, cold stretching of 55% followed by hot stretching of
75% (the numbers in parentheses indicate the standard deviation of the measurements).

| | Mechanical properties | | | Mechanical | | |
|---|---|---|---|---|---|---|
| | along MD | | | properties along TD | | Normalized |
| | Young | Tensile | Strain | Tensile | | maximum force for |
| | modulus | strength | at | strength | Strain | piercing |
| | (MPa) | (MPa) | break | (MPa) | at break | (N/μm) |
| PP | 335.0 (69.5) | 119.0 (25.1) | 0.62 (0.07) | 10.9 (1.5) | 0.07 (0.01) | 0.14 (0.02) |
| HDPE | 315.8 (39.9) | 127.3 (11.1) | 0.79 (0.14) | 75 (0.2) | 2.70 (0.36) | 0.08 (0.01) |
| PP/HDPE/PP | 320.7 (46.0) | 121.7 (21.5) | 0.82 (0.09) | 11.1 (1.0) | 1.80 (0.51) | 0.12 (0.01) |

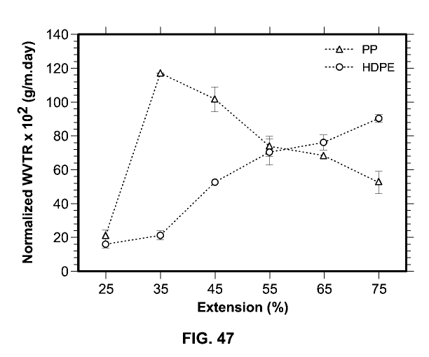

In the preparation of porous membranes using the stretching technique, voids are formed by cold stretching and enlarged by subsequent hot stretching [59,60]. According to Johnson [60], the micro void morphologies produced via this method are a consequence of inter lamellar separation, which takes place at temperatures above T_{g} of the specific semicrystalline polymers. Sadeghi et al. [62] found that the pores size of the cold stretched films obtained from the PP resins with distinct M_{w} did not vary significantly. However, a difference in the lamellae thickness was observed. Our previous study [63] showed that the water vapor transmission rate (WVTR) of the cold stretched PP films increased as the stretch ratio increased up to 30% while further stretching resulted in a reduction in WVTR. To find the optimum cold stretching extension for the present PP as well as the HDPE, cold stretching was carried out under predetermined levels of extension while the amount of hot stretching was kept constant. FIG. 47 reports the WVTR values normalized (multiplied) by the membrane thickness as a function of applied extension for the PP and HDPE monolayer porous membranes. It is obvious that 25% extension during cold stretching is not enough to initiate pores formation for the HDPE and PP. A monotonous increase in WVTR of the HDPE membranes was observed after further extension during cold stretching. In contrast, a significant enhancement in WVTR of the PP membranes was observed when 30% extension was applied while further stretching reduced the normalized WVTR. Additionally, it is clear that both the PP and HDPE have almost identical permeabilities at 55% cold drawing. Therefore, 55% was found to be the optimum cold stretching extension for the fabrication of the multilayer membranes.

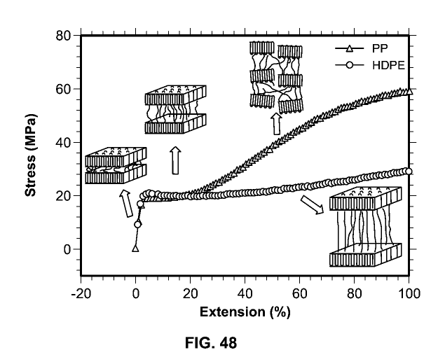

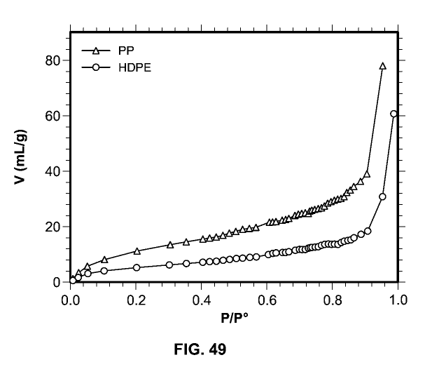

To clearly understand the reasons for the opposite extension dependence of the PP and HDPE in the first stretching step, we show in FIG. 48 the stress-strain responses along MD during cold stretching as well as sketches illustrating the morphology evolution. The stress-strain response for the PP exhibits an elastic response at low deformations, plastic behavior at medium deformations, and strain hardening at high elongations. Compared to the PP, the HDPE displays a wider plastic deformation zone and a strain-hardening region with much lower slope. In the elastic region, the extension is not enough to initiate pores formation whereas in the plastic zone the lamellae begin to separate and an increased extension enlarges the pores size [67]. According to Zue et al. [81], for PP at low temperatures, as the chain mobility is relatively low, tie chains from entanglements may initiate fragmentation of neighboring crystal lamellae upon stretching. In fact, in the strain-hardening zone, the load is transferred to the tie chains [82], hence the continuous increase in stress leads to lamellae fragmentation (see the sketches in FIG. 48). In FIG. 48, it is obvious that 35% extension is the onset of strain-hardening for the PP. Therefore cold stretching of the PP beyond 35% reduces the crystal alignment, yielding a lower permeability. However, due to the wider plastic region for the HDPE, possibly due to the longer tie chains than for the PP, increasing the level of extension monotonically promotes lamellae separation without breaking lamellae, resulting in an enhancement of WVTR with increasing elongation. To confirm these results, we moreover used BET to determine the pore volume and specific surface area of the membranes obtained for 35% cold stretching followed by 75% hot stretching. The results are presented in FIG. 49. Obviously, at all the range of experimental pressure, the PP membrane adsorbed more nitrogen, indicating greater porosity for the PP membrane compared to the HDPE membrane. The specific surface area of 43.4 and 19.3 m²/g were recorded for the PP and HDPE microporous membranes, respectively, supporting the better porosity for the PP membrane made at 35% cold stretching.

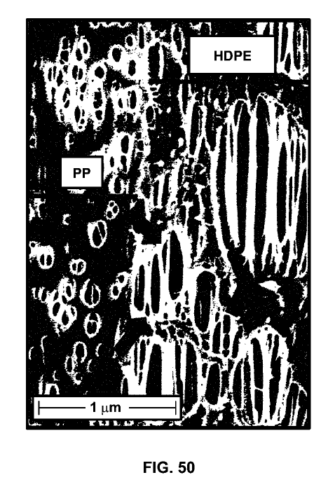

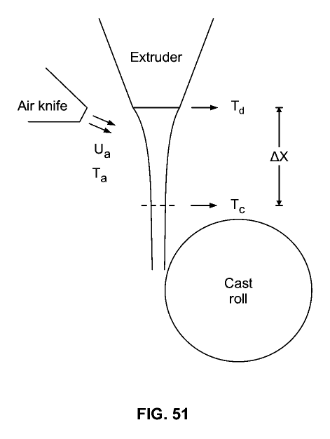

Similar experiments (data not shown) were performed to investigate the influence of hot stretching level. In contrast to the cold stretching behavior of the PP, no maximum was observed when the cold drawn films were stretched to different hot stretch levels. The pores created in cold stretching are enlarged during the hot stretching step and consequently enhance WVTR. More flexibility of the lamellae at high temperatures can be a reason for the increase of pore size with increasing extension ratio. FIG. 50 illustrates the interfacial morphology of the multilayer film membrane prepared with a cold stretching of 55% followed by a hot stretching of 175%. This is 100% more total stretching than for the one shown in FIG. 46. Very large pores, particularly for the HDPE, are seen and that can explain the improvement in WVTR by increasing hot stretching. The arrows in FIG. 50 show the connection between interlamellar microfibrils and the lamellae in the HDPE layer. At such a high level of extension, it is clear that the microfibrils have been connected to the surrounded lamellae by bundles of small blocks. According to Yu [80], at high stretch levels, lamellae located at the end of the microfibrils break into small blocks and tilt along the stretching direction.

Finally, the trilayer microporous membranes obtained at 55% cold extension followed by 75% hot extension showed WVTR values about 30% lower than the monolayer PP and HDPE obtained under the same conditions. This could be due to the presence of the interface and lower orientation of the PP and HDPE components in the multilayer film than the monolayer ones (see FIGS. 40 and 41).

In this work, the structure and performances of microporous membranes made from monolayer and trilayer films of the PP and HDPE have been investigated. Applicants findings can be summarized as follows:
Significant effects of cooling air flow rate (AFR), draw ratio (DR), and annealing on the crystal orientation of the PP and HDPE monolayer films as well as the components in the multilayer one were observed.
At low AFR, the HDPE showed a twisted lamellar morphology whereas at high AFR an intermediate structure between twisted and flat kebabs was detected.
A transcrystallization of the HDPE lamellae penetrating into the PP at the interface of the multilayer films was observed and was explained by the difference in the resin crystallization temperature.
At high cold stretching extensions, the pore size and porosity of the HDPE membranes was much larger compared to those from the PP produced under the same conditions. This was attributed to the longer tie chains in the HDPE membranes compared to the PP.
Good adhesion at the interface of the porous multilayer membrane was attributed to the transcrystallization observed in the precursor film interface.
A pronounced increase in the tensile strength and drastic decreases in modulus and elongation at break along MD were observed for the membranes compared to the precursor films.
By increasing the applied extension during cold stretching, water vapor transmission rate (WVTR) monotonically rose for the HDPE while for the PP, WVTR first increased significantly and then decreased.
The trilayer microporous membranes showed a lower permeability than the monolayer membranes, possibly due to the presence of the interface as well as the lower orientation of the PP and HDPE components in the multilayer film compared to the monolayer films.

### REFERENCES

[1] Ajji A, Zhang X, Elkoun S. Polymer 2005; 46:3838-3846.
[2] Coppola S, Balzano L, Gioffredi E, Maffettone P L, Grizzuti N. Polymer 2004; 45:3249-3256.
[3] Doufas A K, Dairanich I S, Mchugh A J. J Rheol 1999; 43:85-109.
[4] Doufas A K, Mchugh A J. J Non-Newtonian Fluid Mech 2000; 92:81-103.
[5] Swartjes F H M. Stress induced crystallization in elongational flow, PhD thesis, Technische Universiteit Eindhoven, 2001.
[6] Agarwal P K, Somani R H, Weng W, Mehta A, Yang L, Ran S, Liu L, Hsiao B. Macromolecules 2003; 36:5226-5235.
[7] Somani R H, Hsiao B S, Nogales A, Srinivas S, Tsou A H, Sics I, Balta-Calleja F J, Ezquerra T A. Macromolecules 2000; 33:9385-9394.
[8] Somani R H, Yang L, Hsiao B S. Polymer 2006; 47:5657-5668.
[9] Tabatabaei S H, Carreau P J, Ajji A. J Membr Sci 2008; 325:772-782.
[10] Fujiyama M, Inata H. J Appl Polym Sci 2002; 84:2157-2170.
[11] Sadeghi F, Ajji A, Carreau P J. Polym Eng Sci 2007; 47:1170-1178.
[12] Alexander L E. X-ray diffraction methods in polymer science, Wiley Inter Science, New York, 1969.
[13] Arroyo M, Lopez-Manchado M A. Polymer 1997; 38:5587-5593.
[14] Olley R H, Bassett D C. Polymer 1982; 23:1707-1710.
[15] Koerner H, Kelley J J, Vaia R A. Macromolecules 2008; 41:4709-4716.
[16] Kawakami D, Burger C, Ran S, Avila-Ortao C, Sics I, Chu B, Chiao S, Hsiao B S, Kikutani T. Macromolecules 2008; 41:2859-2867.
[17] Macro Y, Chevalier L, Chaouche M. Polymer 2002; 43:6569-6574.
[18] Sadeghi F, Ajji A, Carreau P J. J Membr Sci 2007; 292:62-71.
[19] Ajji A, Zhang X, Elkoun S. Polymer 2005; 46:3838-3846.
[20] Klug H P, Alexamder L E. X-ray diffraction procedures, John Wily & Sons, New York, 1954.
[21] Somani R H, Yang L, Zhu L, Hsiao B S. Polymer 2005; 46:8587-8623.
[22] Guinier A, Fournet G. Small-angle scattering of X-rays, New York: Wiley, 1955.
[23] Hedesiu C, Demco D E, Kleppinger. R, Buda A A, Blumich B, Remerie K, Litvinov V M. Polymer 2007; 48:763-777.
[24] Zhang X M, Elkoun S, Ajji A, Huneault M A. Polymer 2004; 45:217-229.
[25] Samuels R J. J Polym Sci Polym Phys Ed 1979; 17:535-568.
[26] Zhou H, Wilkes G L. J Mater Sci 1998; 33:287-303.
[27] Honerkamp J, Weese J. Rheol Acta 1993; 32:65-73.
[28] Tian J, Yu W, Zhou C. J Appl Polym Sci 2007; 104:3592-3600.
[29] F. Sadeghi, Developing of microporous polypropylene by stretching, Ph. D thesis, Ecole Polytechnique, Montreal, 2007.
[30] M. B. Johnson, Investigations of the processing-structure-property relationship of selected semi crystalline polymers, Ph. D thesis, Virginia Polytechnic Institute and State University, 2000.
[31] P. K. Agarwal, R. H. Somani, W. Weng, A. Mehta, L. Yang, S. Ran, L. Liu, B.
Hsiao, Shear-induced crystallization in novel long chain branched polypropylenes by in situ rheo-SAXS and -WAXD, Macromolecules 36 (2003) 5226.
[32] R. H. Somani, B. S. Hsiao, A. Nogales, Structure development during shear flow induced crystallization of i-PP: in situ wide-angle X-ray diffraction study, Macromolecules 33 (2000) 9385.
[33] R. H. Somani, L. Yang, B. S. Hsiao, Effects of molecular weight species on shear-induced orientation and crystallization of isotactic polypropylene, Polymer 47 (2006) 5657.
[34] M. Seki, D. W. Thurman, P. J. Oberhauser, J. A. Kornfield, Shear-mediated crystallization of isotactic polypropylene: the role of long chain-long chain overlap, Macromolecules 35 (2002) 2583.
[35] F. Sadeghi, A. Ajji, P. J. Carreau, Orientation analysis of row nucleated lamellar structure of polypropylene obtained from cast film, Polym. Eng. Sci. 47 (2007) 1170.
[36] F. Sadeghi, A. Ajji, P. J. Carreau, Analysis of microporous membranes obtained from polypropylene films by stretching, J. Membr. Sci. 292 (2007) 62.
[37] F. Sadeghi, A. Ajji, P. J. Carreau, Study of polypropylene morphology obtained from blown and cast film processes: initial morphology requirement for making porous membrane by stretching, J. Plastic Film Sheet. 21 (2005) 199.
[38] F. Sadeghi, A. Ajji, P. J. Carreau, Microporous membranes obtained from polypropylene blends with superior permeability properties, J. Polym. Sci., Polym. Phys. 46 (2008) 148.
[39] M. Fujiyama, H. Inata, Rheological properties of metallocene isotactic polypropylenes, J. Appl. Polym. Sci. 84 (2002) 2157.
[40] I. M. Ward, P. D. Coates, M. M. Dumoulin, Solid Phase Processing of Polymers, Hanser, 2000.
[41] S. Brunauer, P. H. Emmett, E. Teller, Adsorption of gases in multimolecular layers, J. Am. Chem. Soc. 60 (1938) 309.
[42] J. Li, B. D. Favis, Characterizing co-continuous high density polyethylene/polystyrene blends, Polymer 42 (2001) 5047.
[43] L. A. Utracki, B. Schlund, Linear low density polyethylene and their blends: Part 4 shear flow of LLDPE blends with LLDPE and LDPE, Polym. Eng. Sci. 27 (1987) 1512.
[44] J. Honerkamp, J. Weese, A non linear regularization method for the calculation of relaxation spectra, Rheol. Acta 32 (1993) 65.
[45] H. Kwang, D. Rana, K. Cho, J. Rhee, T. Woo, B. H. Lee, S. Choe, Binary blends of metallocene polyethylene with conventional polyolefins: rheological and morphological properties, Polym. Eng. Sci. 40 (2000) 1672.
[46] L. A. Utracki, in Two Phase Polymer Systems, Hanser Publisher, New York, 1991.
[47] M. B. Johnson, G. L. Wilkes, Microporous membranes of polyoxymethylene from a melt-extrusion process: (I) Effects of resin variables and extrusion conditions, J. Appl. Polym. Sci. 81 (2000) 2944.
[48] M. B. Johnson, G. L. Wilkes, Microporous membranes of polyoxymethylene from a melt-extrusion process: (II) Effects of thermal annealing and stretching on porosity, J. Appl. Polym. Sci. 84 (2002) 1762.
[49] T. H. Yu, Processing and structure-property behavior of microporous polyethylene: From resin to final film, PhD Thesis, Virginia Polytechnic Institute and State University, 1996.
[50] D. Ferrer-Balas, M. L. L. Maspoch, A. B. Martinez, O. O. Santana, Influence of annealing on the microstructural, tensile and fracture properties of polypropylene films, Polymer 42 (2001) 1697.
[51] L. E. Alexander, X-ray Diffraction Methods in Polymer Science, Wiley Inter science, New York, 1969.
[52] W. B. Baker, Membrane Technology and Applications, 2^{nd} ed., John Wiley & Sons, 2004.
[53] F. Chu, Y. Kimura, Structure and gas permeability of microporous film prepared by biaxial drawing of the beta-form polypropylene, Polymer 37 (1996) 573.
[54] Venugopal G, Moore J, Howard J, Pendalwar S. J Power Sourc 1998; 77:34-41.
[55] Dahn J R, Fuller E W, Obrovac M, van Sacken U. Solid State Ionics 1994; 69:265-270.
[56] Wei X, Haire C. 20070196638A1, 2007 US patent.
[57] Gozdz A S, Schmtz C N, Tarascon J M, Warren P C. 5607485, 1997 US patent.
[58] Okazaki M A, kuwana M I, Nagoya S T, Kasugai T I. 4921653, 1990 US patent.
[59] Sadeghi F. Developing of microporous polypropylene by stretching, Ph. D thesis, Ecole polytechnique de Montreal, 2007.
[60] Johnson MB. Ph. D thesis, Virginia Polytechnic Institute and State University, 2000.
[61] Sadeghi F, Ajji A, Carreau P J. Polym Eng Sci 2007; 47:1170-1178.
[62] Sadeghi F, Ajji A, Carreau P J. J Membr Sci 2007; 292:62-71.
[63] Tabatabaei S H, Carreau P J, Ajji A. J Membr Sci 2008; 325:772-782.
[64] Sadeghi F, Ajji A, Carreau P J. J Polym Sci Polym Phys 2008; 46:148-157.
[65] Tabatabaei S H, Carreau P J, Ajji A. Submitted to Polymer.
[66] Arroyo M, Lopez-Manchado M A. Polymer 1997; 38:5587-5593.
[67] Ajji A, Sammut P, Huneault M A. J Appl Polym Sci 2003; 88:3070-3077.
[68] Ward I M, Coates P D, Dumoulin M M. Solid Phase Processing of Polymers 2000 Hanser publisher.
[69] Alexander L E. X-ray diffraction methods in polymer science, Wiley Inter Science, New York, 1969.
[70] Olley R H, Bassett D C. Polymer 1982; 23:1707-1710.
[71] Brunauer S, Emmett P H, Teller E. J Am Chem Soc 1938; 60:309-319.
[72] Li J, Favis B D. Polymer 2001; 42:5047-5053.
[73] Honerkamp J, Weese J. Rheol Acta 1993; 32: 65-73.
[74] Keum J K, Burger C, Zuo F, Hsiao B S. Polymer 2007; 48:4511-4519.
[75] Ajji A, Zhang X, Elkoun S. Polymer 2005; 46:3838-3846.
[76] Zhang X, Ajji A. Polymer 2005; 46:3885-3393.
[77] Agarwal P K, Somani R H, Weng W, Mehta A, Yang L, Ran S, Liu L, Hsiao B. Macromolecules 2003; 36:5226-5235.
[78] Somani R H, Yang L, Zhu L, Hsiao B S. Polymer 2005; 46:8587-8623.
[79] Zhang X M, Elkoun S, Ajji A, Huneault M A. Polymer 2004; 45:217-229.
[80] Yu TH. Ph. D thesis, Virginia Polytechnic Institute and State University, 1996.
[81] Zuo F, Keum J K, Chen X, Hsiao B S, Chen H, Lai S Y, Wevers R, Li J. Polymer; 2007:6867-6880.
[82] Samuels R J. J Polym Sci Polym Phys Ed 2003; 17:435-568.

The present disclosure has been described with regard to specific examples. The description was intended to help the understanding of the disclosure, rather than to limit its scope. It will be apparent to one skilled in the art that various modifications may be made to the disclosure without departing from the scope of the disclosure as described herein, and such modifications are intended to be covered by the present document.

1. A method for controlling the morphology of a cast film, said method comprising extruding a cast film by controlling a cooling rate of said cast film by applying on said film a gas at a gas cooling rate of at least about 0.4 cm³/s per kg/hr in accordance with the extrudate flow rate.

2. The method of claim 1, wherein said gas is air.

3-6. (canceled)

7. The method of claim 1, wherein said cast film is prepared by extruding said film at a draw ratio of about 60 to about 90.

8. The method of claim 1, wherein said film has a thickness of about 20 um to about 60 um.

9-17. (canceled)

18. The method of claim 1, wherein said gas cooling rate is of about 0.5 cm³/s to about 9 cm³/s per kg/hr in accordance with the extrudate flow rate.

19. The method of claim 8, wherein said gas cooling rate is of about 0.5 cm³/s to about 5.5 cm³/s per kg/hr in accordance with the extrudate flow rate.

20. (canceled)

21. The method of claim 1, wherein said gas cooling rate is at least proportional to square of the extrudate flow rate.

22. The method of claim 1, wherein said gas cooling rate is proportional to the reciprocal of extrudate film width.

23. The method of claim 1, wherein said film is extruded by means of a die and rolled up on a at least one cooling drum.

24-27. (canceled)

28. The method of claim 23, wherein said at least one cooling drum is at a temperature of about 80° C. to about 130° C.

29. (canceled)

30. The method of claim 23, wherein said at least one cooling drum is at a temperature of about 90° C. to about 120° C.

31-37. (canceled)

38. The method of claim 1, wherein said film comprises a polymer chosen from polypropylene, linear polypropylene, polyethylene and high density polyethylene.

39-47. (canceled)

48. A method for preparing a microporous membrane comprising preparing a cast film by controlling the morphology of said cast film as described in claim 1, annealing said film, and stretching said film.

49. The method of claim 48, wherein said film is annealed at a temperature below the melting temperature.

50-51. (canceled)

52. The method of claim 49, wherein said film is annealed at about 120° C. to about 140° C.

53. The method of claim 48, wherein said film is stretched at a first temperature and said film is stretched at a second temperature.

54. (canceled)

55. The method of claim 53, wherein said first temperature is about 15° C. to about 40° C. and said second temperature is about 100° C. to about 140° C.

56-61. (canceled)

62. The method of claim 55, wherein said film is stretched of about 30% to about 40% at said first temperature and said film is stretched of about 50 to about 60% at said second temperature or said film is stretched of about 50% to about 60% at said first temperature and said film is stretched of about 70 to about 80% at said second temperature.

63. (canceled)

64. A multilayer microporous membrane comprising at least two cast films prepared by controlling the morphology of said cast films as described in claim 1.

65-81. (canceled)

82. A method of preparing a microporous membrane comprising preparing a multilayer cast film, annealing said film, and stretching said film, wherein said multilayer cast film comprises, in the following order, a first polypropylene layer, a polyethylene layer, and a second polypropylene layer.

83. (canceled)
